(19) United States
(12) Patent Application Publication
(10) Pub. No.: US 2023/0075931 A1
(43) Pub. Date: Mar. 9, 2023

(54) Transpositive Network For Converting Variable-Volume Fixed-Value Units To Fixed-Volume Variable-Value Units And Vice Versa

(71) Applicants: Brandia Rae Tanaka, (US); Philip Nobuyuki Tanaka, (US)

(72) Inventors: Philip Nobuyuki Tanaka, Belgrade, MT (US); Brandia Rae Tanaka, Belgrade, MT (US)

(21) Appl. No.: 17/989,270

(22) Filed: Nov. 17, 2022

Related U.S. Application Data
(63) Continuation of application No. PCT/US2022/025778, filed on Apr. 21, 2022.
(60) Provisional application No. 63/258,323, filed on Apr. 21, 2021.

(51) Int. Cl. G06Q 40/04; G06Q 20/06

(52) U.S. Cl. CPC G06Q 40/04; G06Q 20/065

(57) ABSTRACT

In a general aspect, a transpositive network is configured for converting variable-volume fixed-value units to fixed-volume variable-value units and vice versa. In some aspects, a computer system includes means for transposing between a variable-volume fixed-value (VVFV) item comprising VVFV units and a fixed-volume variable-value (FVVV) item comprising FVVV units. The means for transposition implements one or more transpositive network rules.

### CROSS-REFERENCE TO RELATED APPLICATIONS

This application claims priority to U.S. Provisional Application No. 63/258,323 filed Apr. 21, 2021, and entitled “Private Currency Paired With Interest in pooled units Further Paired With External Stores Of Value.” The above-referenced priority application is hereby incorporated by reference.

### FIELD OF THE INVENTION

The following description relates to enabling use of variable-volume, fixed-value units as fixed-volume, variable value units and vice versa, through a multi-step transpositive network operating according to specific transpositive network principles.

In various contexts, the property characteristics of certain elements existing in a network limit or prevent a desired function. In such cases, a method or system for transposing an element of certain properties and functionalities to another element of varying properties and functionalities, while preserving a value continuation and fluctuation between the two disparate elements, provides valuable flexibility and opportunities to benefit from the properties and functionalities of both elements in the same network. The present disclosure enables such goals.

### BRIEF DESCRIPTION OF THE DRAWINGS

FIG. 1 is a block diagram depicting a Transpositive Network Computing System.

FIG. 2 is a diagram depicting a Transpositive Node Network.

FIG. 3 is a diagram depicting a Transpositive Node Network with Companies.

FIG. 4 is a diagram depicting possible elements of a Transaction Instance.

FIG. 5 is a diagram depicting possible elements of an Interest in Pooled Unit Entry.

FIG. 6 is a diagram depicting possible elements of a Pairing Record.

FIG. 7 is a flow chart showing an example process for generation of Transaction Instance, Interest in Pooled Unit and Pairing Record.

FIG. 8 is a flow chart showing an example process for determining value of Transaction Instance and Interest in Pooled Unit, and quantity of Interest in Pooled Unit and FVVVs to be transferred.

FIG. 9 is a flow chart showing properties and pairing of Transpositive Items.

FIG. 10 is a flow chart showing an example process for transfer of Transaction Instances and Interest in Pooled Units.

FIG. 11 is a flow chart showing an example process for fractionalization of Transaction Instances and Interest in Pooled Units.

FIG. 12 is a flow chart showing an example process for defractionalization of Transaction Instance and Interest in Pooled Units.

FIG. 13 is a flow chart showing an example process for paying Microtransaction Fee (MTF) for TI.

FIG. 14 is a flow chart showing an example process for pooling of Transaction Instances for MTF calculation.

FIG. 15 is a diagram depicting network participation rewards (NPR).

FIG. 16 is a diagram depicting dividend payments for Transaction Instances.

FIG. 17 is a diagram depicting pooling of Transaction Instances for dividend payments.

FIG. 18 is a diagram depicting retirement of Transaction Instances and Interest in Pooled Units.

FIG. 19 is a diagram depicting partial appreciation participation.

FIG. 20 is a diagram depicting function of paired Transaction Instances and Interest in Pooled Units.

FIG. 21 is a diagram depicting VVFV Unit and Transaction Instance correspondence and use.

FIG. 22 is a diagram depicting multiple pairing among Interest in Pooled Units, Transaction Instances, VVFV and an external currency.

FIG. 23 is a diagram depicting display options.

FIG. 24 is a diagram depicting a transpositive request from VVFV to Interest in Pooled Unit to FVVV.

FIG. 25 is a diagram depicting transfer of Interest in Pooled Units.

FIG. 26 is a diagram depicting fractionalization of Interest in Pooled Units.

FIG. 27 is a diagram depicting defractionalization of Interests in Pooled Units.

FIG. 28 is a diagram depicting retirement of Interests in Pooled Units.

### DETAILED DESCRIPTION

100321 Although there exist numerous network ecosystems in which the present disclosure may be applied, in some implementations, the systems and techniques described here can enable entities with the ability to monetize corporate securities into tradable currency, an accomplishment not permitted by the currently separate ecosystems of stablecoins and tokenized securities.

Stablecoins, fiat currencies and other units of exchange are by nature variable-volume, fixed-value units, while corporate securities and other stores of value such as Bitcoin, other cryptocurrencies and commodities, are by nature fixed-volume, variable-value units, and these two categories cannot be used interchangeably due to such apposite characteristics. By application of a series of transpositive network principles, through sequential and variable literal and value-equivalence pairing and pooling, the interference obstructing full circuitry of currency and corporate securities may be removed, as one example.

In all instances and embodiments described in this disclosure: all steps in the figures may occur in varying orders and not all steps are shown, and not all steps shown are necessarily required; where reference to a Client Node is made as having a particular role, given that a Client Node has the lowest functionality of any Node, such role and function may be undertaken by any other Node in the system, e.g., Merchant Node, Company Node or Transpositive Node; none of such approaches herein are exclusive and each may be combined with one or more other approaches depending on the desired configuration; any step described as to any financial instrument or store of value may be accomplished either with the specific asset or a derivative instrument representing such asset, provided that such derivative instrument is legally binding and valid. For example, any instance of pairing for value in a pool of FVVVs may be accomplished with the actual FVVVs, or through derivatives or other financial instruments providing approximately the same performance thereof; in all steps of execution of software in a module stored in Node storage, such execution includes such software and the relevant data being loaded into the appropriate memory to enable the desired operation conducted by the Node processor; separate elements of TI and IPU, in some embodiments, may be combined into a single unit of unified currency where the functionality of TI and IPU are consolidated into one instantiation of currency in the Network. In such cases, all references to either TI or IPU shall be construed to be references to such unified currency; where reference to the Transpositive Node Network or Network is made, such reference may alternatively refer to a distributed ledger technology (DLT) implementation of the Network where one or more Nodes, possibly Transpositive Nodes, act on a federated, deterministic basis to validate, record and search transactions recorded in a private, semi-public or public blockchain.

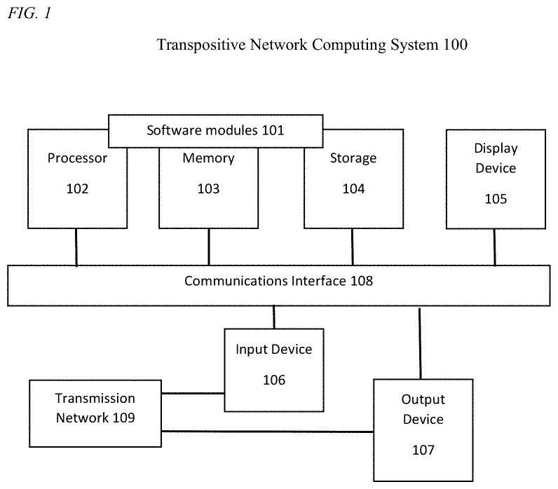

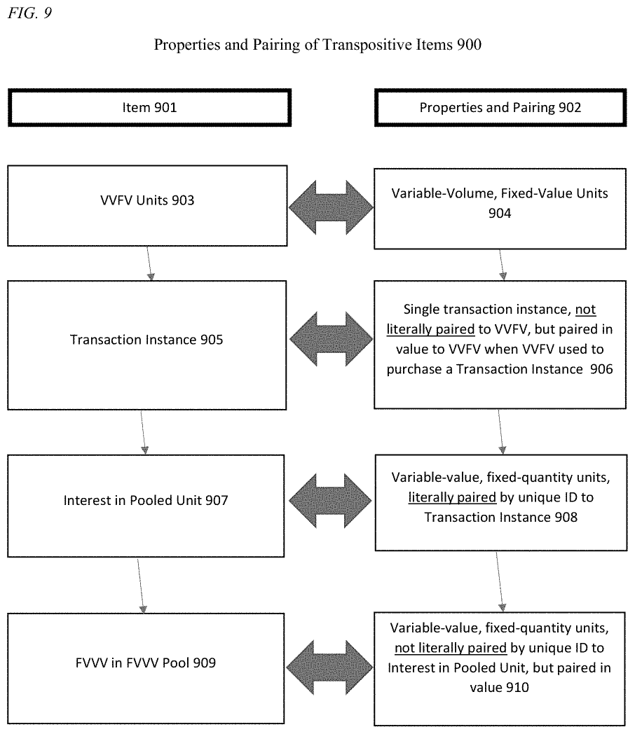

FIG. 1 is a diagram depicting a Transpositive Network Computing System 100. A Transpositive Network Computing System 100 includes one or more software modules existing in storage, loaded into memory or executing on a processor 101, one or more processors 102, various types of memory 103, one or more types of storage 104 and one or more display devices 105, one or more input devices 106, one or more output devices 107, which may all be linked together by a communications interface 108, with the input devices and output devices potentially linked to a communications network 109. In some implementations, the transpositive network computing system 100 is implemented to perform operations in the example processes 900, 1000, 1100, 1200, 1300, 1400, 1500, 1600, 1700, 1800, 1900, 2000, 2100, 2200, 2400, 2500, 2600, 2700, 2800 in FIGS. 9-22 and 24-28, or in another manner.

All software in modules 101 containing instructions shall reside in the cache of the processor 102, memory 103 or storage 104, with data being presented on the display 105 and stored in storage 104.

The Transpositive Network Computing System processor 102 may be one or more processors or integrated circuits with specialized functions, integrated with various levels of cache. The communications interface 108 may include an I/O interface, communications interface and bus. Memory 103 may include various forms of memory such as flash, RAM, DRAM or a combination of memory types. Storage 104 may include solid state drives, hard drive, USB drive, SD cards, DVDs or other various optical, magnetic or other media.

A Transpositive Network Computing System may serve as a Transpositive Node or a conversion node, Company Node, Client Node, Merchant Node or Third-Party Node or a combination or variation of the foregoing.

As described herein, all steps of receiving data shall occur by the input device 106 and all steps of sending data shall occur by the output device 107. All communications within components of the Transpositive Network Computing System 100 shall occur over the communications interface 108.

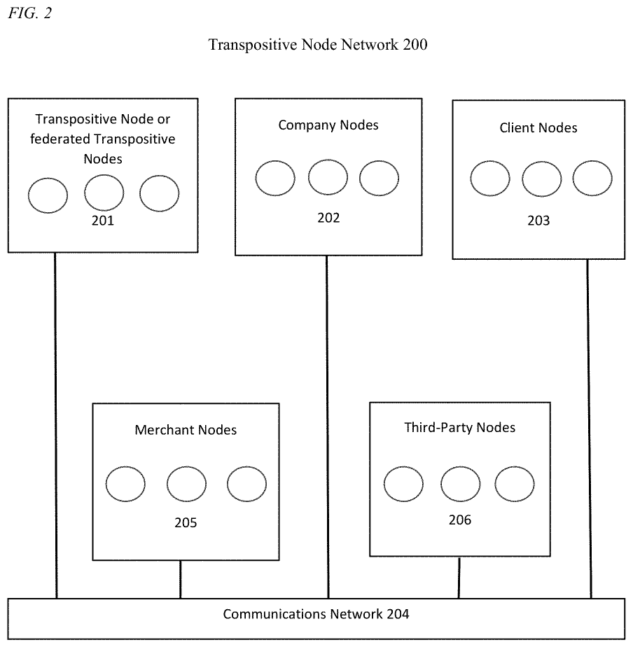

FIG. 2 is a diagram depicting a Transpositive Node Network 200. A Transpositive Node Network 200 may be comprised of a Transpositive Node or federated Transpositive Nodes 201, Company Nodes 202, Client Nodes 203, Merchant Nodes 205, Third-Party Nodes 206, tied together by a communications network 204. In some implementations, the Transpositive Node Network 200 is implemented to perform operations in the example processes 900, 1000, 1100, 1200, 1300, 1400, 1500, 1600, 1700, 1800, 1900, 2000, 2100, 2200, 2400, 2500, 2600, 2700, 2800 in FIGS. 9-22 and 24-28, or in another manner.

In various embodiments, the disclosed technology includes at least one Transpositive Node, one or more Client Nodes, possibly Company Nodes and possibly one or more Merchant Nodes, which may variously communicate and transact with each other, i.e., Client Node to Client Node, Client Node to Merchant Node, Client Node to Transpositive Node, Merchant Node to Transpositive Node, and with outside, Third-Party Nodes. Client Nodes, Merchant Nodes, Company Nodes and Transpositive Nodes may be of one or more classes, differentiated by varying obligations, responsibilities and functionalities.

Client Nodes 203 may display various data, such as data showing current and historical amounts of TI or other stores of value held, histories of transactions, frequent counterparties, loans or indebtedness, accumulation or rewards, availability of other opportunities.

Client Nodes 203 may offer various capabilities, such as initiating the purchase of TI, using TI to purchase goods or services, depositing such TI for various purposes, loaning or borrowing TI, exchanging such TI for other TI or other currencies or stores of value, or financial instruments or investments. Client Nodes 203 may also offer the ability to communicate with other Nodes and to share files or grant limited access to certain data. Authority over Client Nodes 203 may be shared between two or more people, and different persons may be granted different levels of access and privileges. Client Nodes 203 may enable the ability to be accessed simultaneously from more than one location, and may provide additional layers of information regarding access and security. Client Nodes 203 may request upgrades or downgrades in account limits or access to additional features or functionality.

Merchant Nodes 205 might include all of the capabilities of Client Nodes 203, but might also include more capabilities related to offering goods or services for sale or lease to other Users. Such goods or services might be offered for sale on another system, but the payment therefor could occur through a Transpositive Node Network 200, or be connected to a Transpositive Node Network 200 through one or more interfaces utilizing a common protocol. Merchant Nodes 205 might be capable of offering rewards and loyalty programs, as well as capabilities for calculating advantageous offers or predictions of purchasing patterns. Merchants might be provided the ability to interconnect backend analytics systems with the Transpositive Node Network 200 to optimize consumer prediction and offers, as well as the ability to cooperate with other Merchant Nodes 205 and to form mutually-beneficial federations. Merchant Nodes 205 might have additional, comprehensive reporting functions relating to sales, returns, inquiries, repeat purchases, amount of or frequency of purchases, as well as patterns related thereto. Merchant Nodes 205 might be provided the ability to offer their own TI as a sub-offering in a Transpositive Node Network 200.

Transpositive Nodes 201 might include all of the capabilities of Client Nodes 203, Company Nodes 202 and Merchant Nodes 205, but would also serve as the central processing unit, source-of-truth database and clearinghouse for all TI creation, issuance, exchange and rewards. Transpositive Nodes 201 would maintain the various accounts of Client Nodes 203, Company Nodes 202 and Merchant Nodes 205, which might include VVFV accounts, TI accounts, US Dollar accounts, FVVV accounts, loans and accounts of various other currencies or stores of value. All communications and transactions in the Transpositive Node Network 200 initiated by Client Nodes 203, Company Nodes 202 and Merchant Nodes 205 would be received by the Transpositive Node 201 for processing and recording, or onward transmission to the eventual recipient or for further action.

Transpositive Node responsibilities may be shared by more than one Transpositive Node in a federated manner, where roles and functions are allocated by agreement. Such embodiments might still include a senior Transpositive Node or Transpositive Nodes of varying degrees of responsibility and authority, configured and operated based on such agreement.

In various embodiments, the disclosed technology may enable creation of multiple Transpositive Node Networks with more than one Transpositive Node working together in a coordinated or federated fashion. Such multiple Transpositive Node Networks would include standardization or interoperability in TI Records and calculation of exchange rates and uniformity of User obligations and responsibilities.

In various embodiments, a Network may be implemented using distributed ledger technology (“DLT”) where specified Nodes in the Network, possibly one or more Transpositive Nodes acting in a federated capacity, would be responsible for validating transactions on the official distributed ledger, based on various verification approaches, such as Hashgraph, virtual voting, proof-of-work, proof-of-stake or other consensus algorithms. In such a DLT network, in addition to status as Transpositive Nodes, Company Nodes, Merchant Nodes or Client Nodes, a Node might also serve as a verification Node, in addition to being a reading Node, while some Nodes might be read-only Nodes. Verification Nodes have responsibility for ratifying transactions on the ledger, while read-only Nodes are able to view transactions of the ledger, the ability to write transactions to the ledger would depend on the configuration of the DLT network.

In addition, at times there might be interactions with parties who are external to the Transpositive Node Network, or Third-Party Nodes 206. Such Third-Party Nodes 206 might be financial institutions, foreign entities or individuals not participating in the Transpositive Node Network 200, but with whom there is a need for transactions.

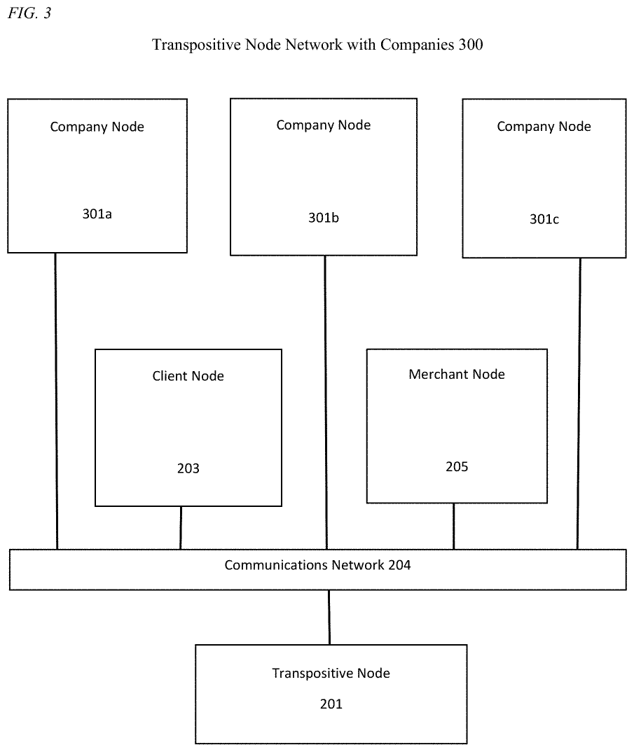

FIG. 3 is a diagram depicting a Transpositive Node Network with Companies 300. A Transpositive Node Network 200 might also be oriented to include several companies 301a, 301b, 301c, as the issuers of FVVVs that are pooled to anchor the value of IPU, where various Nodes, e.g., a Client Node 203, may purchase TI that is tied to the value of an FVVV of one or more companies. In some implementations, the transpositive node network with companies 300 is implemented to perform operations in the example processes 900, 1000, 1100, 1200, 1300, 1400, 1500, 1600, 1700, 1800, 1900, 2000, 2100, 2200, 2400, 2500, 2600, 2700, 2800 in FIGS. 9-22 and 24-28, or in another manner.

In some embodiments, a Transpositive Node Network 200 oriented around multiple companies providing FVVVs would include such companies 301a, 301b, 301c, one or more Client Nodes 203, possibly Merchant Nodes 205, a Transpositive Node 201, all connected together by a communications network 204.

In such embodiments, a Network might be operated by a Transpositive Node equitizing TI with the FVVVs of one or more different companies, with TI being formulated into separate categories based on such companies' FVVVs, and IPU existing in a common pool covering multiple companies' FVVVs, or in separate pools, but in either configuration, such IPU would be paired to TI issued by the Transpositive Node. A Transpositive Node might operate a system of Company-oriented Networks, where each company operates a Network based on its own FVVVs, but such Company-oriented Networks might be tied to and interoperable with an overall Network operated by the Transpositive Node, using TI issued by the Transpositive Node. A Network may also be operated by a single company as the Transpositive Node with its FVVVs forming the only basis for the FVVVs pooled and paired with the IPU.

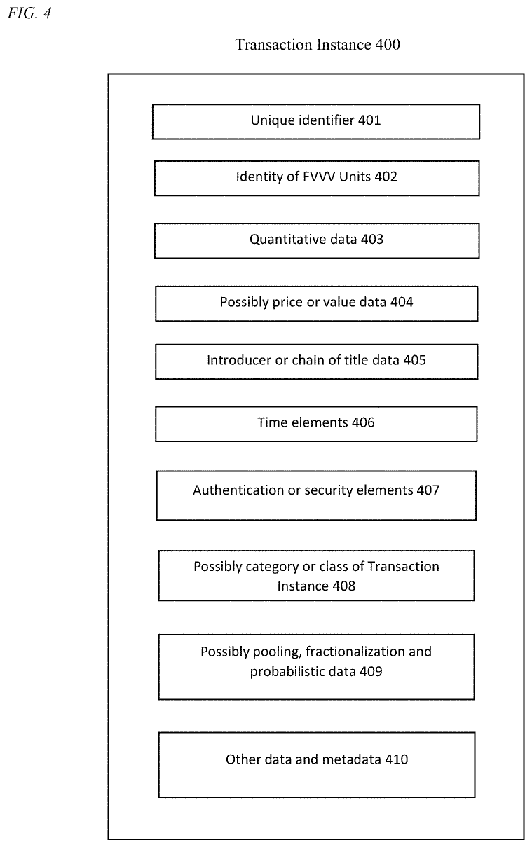

FIG. 4 is a diagram depicting possible elements of a Transaction Instance 400. In various embodiments, at creation of such Transaction Instance (or transaction entry), the Transpositive Node 201 will create a TI record (“TI Record”) 400 possibly including a unique identifier of such TI 401, identity of company issuing FVVVs 402, quantitative data regarding such TI, e.g., number of TI or IPU 403, possibly price or value data 404,

Introducer or chain-of-title data 405, time elements 406, authentication or security elements 407, possibly category or class of TI 408, possibly pooling, fractionalization and probabilistic data 409 and possibly other data and metadata 410.

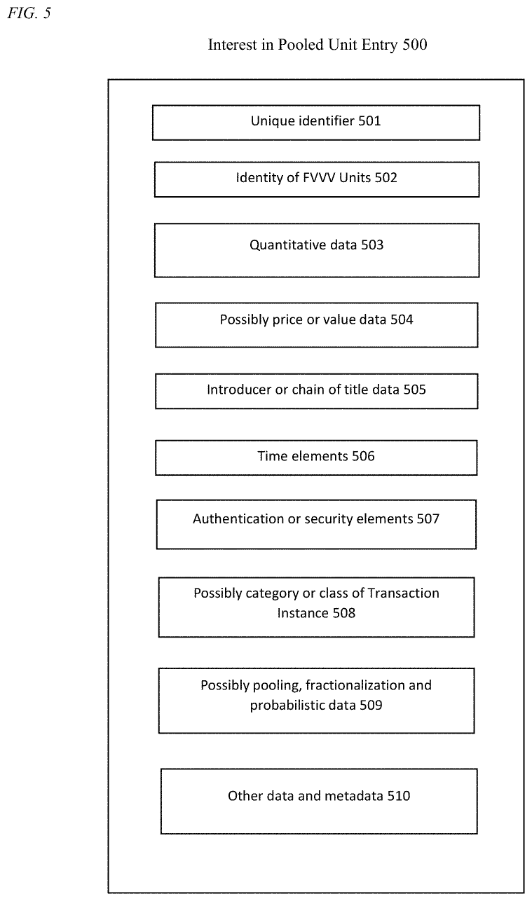

FIG. 5 is a diagram depicting possible elements of an Interest in Pooled Unit Entry 500. In various embodiments, at creation of an Interest in Pooled Unit, the Transpositive Node 201 will create a IPU record (“IPU Record”) 500 possibly including a unique identifier of such IPU 501, identity of company issuing FVVVs 502, quantitative data, e.g., number of IPU or paired FVVVs 503, possibly price or value data 504, Introducer or chain-of-title data 505, time elements 506, authentication or security elements 507, possibly category or class of TI 508, possibly pooling, fractionalization and probabilistic data 509 and possibly other data and metadata 510.

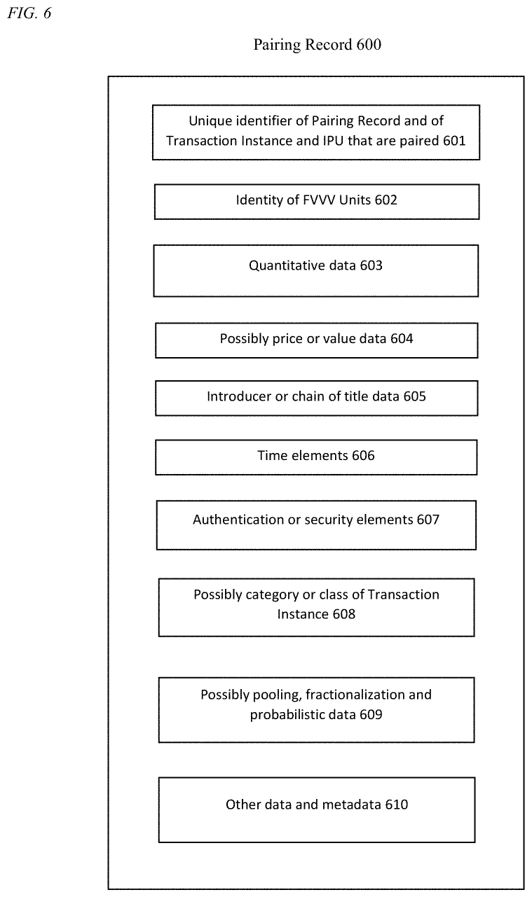

FIG. 6 is a diagram depicting possible elements of a Pairing Record 600. In various embodiments, at pairing of TI and IPU, the Transpositive Node 201 will create a pairing record (“Pairing Record”) 600 possibly including a unique identifier of such Pairing Record 601, identity of company issuing FVVVs 602, quantitative data, e.g., number of IPU or paired FVVVs 503, possibly price or value data 604, Introducer or chain-of-title data 605, time elements 606, authentication or security elements 607, possibly category or class of TI 608, possibly pooling fractionalization and probabilistic data 609 and possibly other data and metadata 610.

In addition, in some embodiments, a Pairing Record might be created between IPU and the FVVV. Such Pairing Record would be substantially similar to the Pairing Record for TI and IPU, with changes made to reflect pairing of IPU and the FVVV.

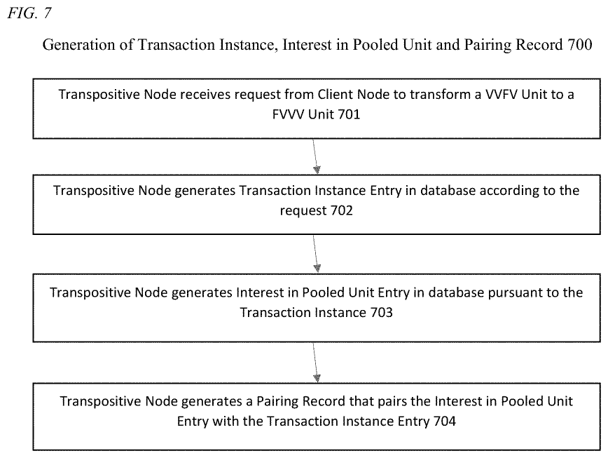

FIG. 7 is a diagram depicting Generation of Transaction Instance, Interest in Pooled Unit and Pairing Record 700. In various embodiments, a Transpositive Node receives a conversion request from Client Node to transform a VVFV Unit to a FVVV Unit 701.

The Transpositive Node 201 generates Transaction Instance Entry in the Transaction Instance Entry database according to the request 702.

The Transpositive Node 201 generates an Interest in Pooled Unit Entry in Interest in Pooled Unit Entry database pursuant to the Transaction Instance 703.

The Transpositive Node 201 generates a Pairing Record that pairs the Interest in Pooled Unit Entry with the Transaction Instance Entry 704.

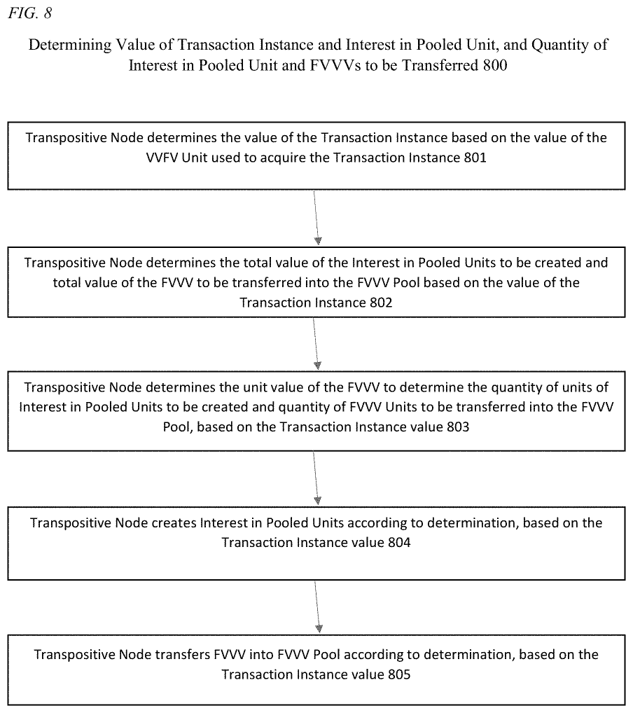

FIG. 8 is a diagram depicting Determining Value of Transaction Instance and Interest in Pooled Unit, and Quantity of Interest in Pooled Unit and FVVVs to be Transferred 800. In various embodiments, the Transpositive Node 201 determines the value of the Transaction Instance based on the value of the VVFV Unit used to acquire the Transaction Instance 801.

The Transpositive Node 201 determines the total value of the Interest in Pooled Units to be created and total value of the FVVV to be transferred into the FVVV Pool based on the value of the Transaction Instance 802.

The Transpositive Node 201 determines the unit value of the FVVV to determine the quantity of units of Interest in Pooled Units to be created and quantity of FVVV Units to be transferred into the FVVV Pool, based on the Transaction Instance value 803. If dividends, partial appreciation participation or other events occur with respect to IPU, the impact of certain events shall be carried over to the Introducer of the TI or the holder of the IPU.

FIG. 9 is a diagram depicting Properties and Pairing of Transpositive Items 900. In various embodiments, the Transpositive Network Computing System 100 accomplishes an unconventional transposition between Variable-Volume, Fixed-Value Units 903 to Fixed-Volume, Variable-Value Units 909, and vice-versa. This transposition is difficult because the two elements being transposed possess different properties and may only be converted back and forth through a multi-tiered system of variable literal and quantity equivalence pairing intermediated by creation of interest in pooled units operating according to specified rules.

Activation of the Transpositive Network Computing System 100 begins with an input of Variable-Volume, Fixed-Value Units 903, possessing such properties 904.

100661 The input into the Transpositive Network 100 of a certain quantity of Variable-Volume, Fixed-Value Units 903 results in the generation of a Transaction Instance 905. The Transaction Instance 905 is not literally paired by unique identification to the Variable-Volume, Fixed-Value Units 903, but at generation, there is a value equivalence between the Transaction Instance 905 and the Variable-Volume,

Fixed-Value Units 903. This value equivalence only necessarily exists at generation of the Transaction Instance 905 due to the fact that at later timepoints the value of the Transaction Instance 905 might fluctuate and such fluctuation would result in being equivalent to a greater or lesser quantity of Variable-Volume, Fixed-Value Units 903.

The generation of the Transaction Instance 905 results in the generation of the Interest in Pooled Units 907. The Interest in Pooled Units 907 are fixed-volume variable-value units, possessing opposite properties from the Variable-Volume, Fixed-Value Units 903, which served as the initial input to the Transpositive Network Computing System 100. The Interest in Pooled Units 907 are tied by literal pairing and unique identification with the Transaction Instance 905. The literal pairing between the Transaction Instance 905 and the Interest in Pooled Units 907 continues throughout the existence of such two items in the Transpositive Network Computing System 100, wherein neither the Transaction Instance 905 nor the Interest in Pooled Units 907 can be generated, transferred, fractionalized, defractionalized or retired without the same operation occurring to the other.

Part of the pairing between the Transaction Instance 905 and the Interest in Pooled Units 907 is such that the values of the Transaction Instance 905 and the Interest in Pooled Units 907 are always equivalent.

However, value equivalence between the Transaction Instance 905 and the Interest in Pooled Units 907 does not result in quantity equivalence due to the fact that a Transaction Instance 905 is a singular document recording a specific transaction. As a singular transaction record, its quantity can be understood to be one, while it might possess a value of a variable quantity of Interest in Pooled Units 907 to which it is paired. That quantity relationship between the Transaction Instance 905 and the Interest in Pooled Units 907 is fixed at generation and does not change, thus if a specific Transaction Instance 905 is equivalent to ten Interest in Pooled Units 907, it will always be equivalent to ten Interest in Pooled Units 907.

An important function in generation of items being transposed in the Transpositive Network Computing System 100 is the quantity determination of the Interest in Pooled Units 907. At generation, the Transpositive Node 201 ascertains the unit value of the Fixed-Volume, Variable-Value Units 909 at the endpoint of the transposition. Based on this unit value of the Fixed-Volume, Variable-Value Units 909, the Transpositive Node 201 divides the value of the Transaction Instance 905 by the unit value of the Fixed-Volume, Variable-Value Units 909 to determine the quantity of Fixed-Volume, Variable-Value Units 909 that will be transferred into the Fixed-Volume, Variable-Value Units Pool 910.

The determination of the quantity of the Fixed-Volume, Variable-Value Units 909 also determines the quantity of the Interest in Pooled Units 907. The overall quantity of Interest in Pooled Units 907 in the Transpositive Network Computing System 100 is always equivalent to the quantity of Fixed-Volume, Variable-Value Units 909 in the Fixed-Volume, Variable-Value Units Pool 910. In addition to being paired in quantity, the Interest in Pooled Units 907 are paired in value with the Fixed-Volume, Variable-Value Units 909, as the value of the Fixed-Volume, Variable-Value Units 909 determines the value of the Interest in Pooled Units 907. Unlike the literal pairing between a Transaction Instance 905 and an Interest in Pooled Unit 907, the Interest in Pooled Unit 907 and the Fixed-Volume, Variable-Value Units 909 are not literally paired with each other, but only are paired in quantity equivalence, such that if one Interest in Pooled Unit 907 is generated, one unit of Fixed-Volume, Variable-Value Unit 909 must be transferred into the Fixed-Volume, Variable-Value Units Pool 910.

In addition, the value of the Interest in Pooled Units 907 determines the value of the Transaction Instance 905 to which such Interest in Pooled Units 907 are paired. Further, the value of the Transaction Instance 905 can be expressed in Variable-Volume, Fixed-Value Units 903, where such expression is merely an informational item on a Client Node 203 display, or the Transpositive Network Computing System 100 may dynamically add or subtract Variable-Volume, Fixed-Value Units 903 to or from the account of the associated Client Node 203 in accordance with the fluctuation of value of the Transaction Instance 905. Alternatively, rather than real-time addition and subtraction, the Transpositive Node 201 can display a running balance of Variable-Volume, Fixed-Value Units 903, but only create instantiations of the same upon demand for transfer or retirement.

In summary, the following are rules for operating a Transpositive Network Computing System 100 capable of transposing Variable-Volume, Fixed-Value Units to Fixed-Volume, Variable-Value Units, and vice versa:
1. At inception, the value of the input of Variable-Volume, Fixed-Value Units will be equivalent to the value of the output of the created Transaction Instance.
2. At inception, the quantity of the input of Variable-Volume, Fixed-Value Units is not required to be equivalent with the quantity of the output of the created Transaction Instance.
3. At inception, the Variable-Volume, Fixed-Value Units are not paired by unique identification with the Transaction Instance, but are paired only in equivalent value.
4. At inception, the value of the input of the Transaction Instance will be equivalent to the value of the output of the created Units of Pooled Interests.
5. At inception, the quantity of the input of Transaction Instance is not required to be equivalent with the quantity of the output of the created Units of Pooled Interest.
6. At inception, the Transaction Instance is paired by unique identification with the Units of Pooled Interests.
7. At inception, the value of the input of the Units of Pooled Interests will be equivalent to the value of the output of the identified Fixed-Volume, Variable Value Units that are transferred into the Fixed-Volume, Variable Value Units Pool.
8. At inception, the quantity of the input of the Units of Pooled Interests will be equivalent with the quantity of the output of Fixed-Volume, Variable Value Units.
9. At inception, the Units of Pooled Interests are not paired by unique identification with the Fixed-Volume, Variable Value Units, but are paired only in equivalent value.
10. At inception, the quantity of Fixed-Volume, Variable Value Units will be determined by dividing the unit price of the Fixed-Volume, Variable Value Units by the value of the Transaction Instance, which is equivalent with the value of the Units of Pooled Interests.
11. At inception, the input of the quantity of Fixed-Volume, Variable Value Units will be equivalent to the output of the quantity of Units of Pooled Interests.
12. During all operations of the Network, wherein Variable-Volume, Fixed-Value

Units are being transposed to Fixed-Volume, Variable Value Units, and vice-versa, the following rules shall continue to apply: 2, 3, 4, 5, 6, 7, 8, 9 and 11.
13. At a request of transfer of a Transaction Instance, the transfer request may be expressed in Variable-Volume, Fixed-Value Units.
14. At a request of transfer, the value of the transfer request expressed in Variable-Volume, Fixed-Value Units will be mapped to the value of one or more Transaction Instances, with such Transaction Instances being identified to be subject to the transfer.
15. At a request of transfer, where the value of a transfer request is not equivalent to the value of a Transaction Instance, a Transaction Instance may be fractionalized to be equivalent with the value of the transfer request by creating two descendant Transaction Instances, one of which is in the desired fractionalization and the other being the remainder.
16. At a request of transfer, the identified Transaction Instance and the identified fractionalized, descendant Transaction Instance will be transferred.
17. At a request of transfer, where a Transaction Instance is transferred, the paired Units of Pooled Interest will be correspondingly transferred.
18. At a request of transfer, where a Transaction Instance has been fractionalized for transfer, the paired Units of Pooled Interest will be correspondingly fractionalized, and the identified descendant fractionalized Units of Pool Interest will be correspondingly transferred.
19. At a request of transfer, where a Transaction Instance and a Units of Pooled Interests have been fractionalized, the descendant Transaction Instance and descendant Unit of Pool Interests that have not been transferred will remain with the transferor.
20. At a request of transfer, where the recipient of the transfer is not in the network, the relevant Transaction Instance and Units of Pooled Interests will be deemed retired from the network, and the equivalent value of Fixed-Volume, Variable Value Units will be transferred out of the Fixed-Volume, Variable Value Units Pool and liquidated to an acceptable medium of exchange to be transferred to the out-of-network recipient.

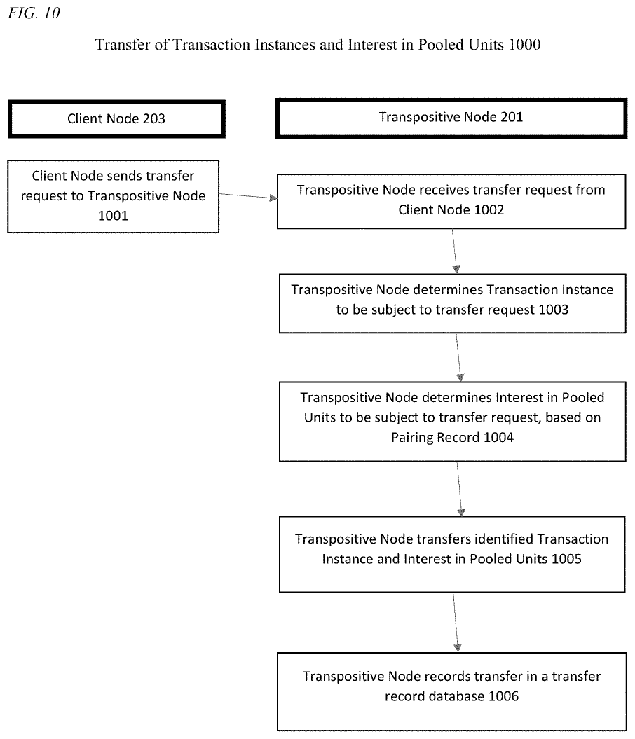

FIG. 10 is a diagram depicting Transfer of Transaction Instances and Interest in Pooled Units 1000. A User might desire to use or spend an amount of a Transaction Instance and such use or spending requires transfer of such Transaction Instance. In some embodiments, a Client Node 203 sends a transfer request to the Transpositive Node 201, which could include data regarding amount and transferee, and may also include preferences regarding which Transaction Instance or category of Transaction Instance is to be used in such transfer request. In such cases, the Transpositive Node 201 receives from the Client Node 203 the transfer request 1002. In some implementations, the example process is performed by the example network 100, 200, 300 shown in FIGS. 1-3.

The Transpositive Node 201 determines the Transaction Instance that will be subject to transfer request 1003, according to Client Node preferences or network principles.

The Transpositive Node 201 determines the Interest in Pooled Units to be subject to transfer request, based on the Pairing Record 1004.

The Transpositive Node 201 transfers identified Transaction Instance and Interest in Pooled Units 1005.

The Transpositive Node 201 records the transfer in a transfer record database 1006.

In some embodiments, Users might be provided options regarding what units of TI they desire to transfer, as different units will have different values and attributes. For example, in some embodiments, Users might default to transferring the most recently acquired TI first if incentives or rewards are provided for holding TI over a longer time period. Users might prefer to transfer TI with the lowest FVVV purchase price, or to spend TI based on a unified average of all TI held. If dividends are paid in connection with such TI, accounting for the impact of spending TI eligible for dividend participation could factor into the decision regarding which TI to spend.

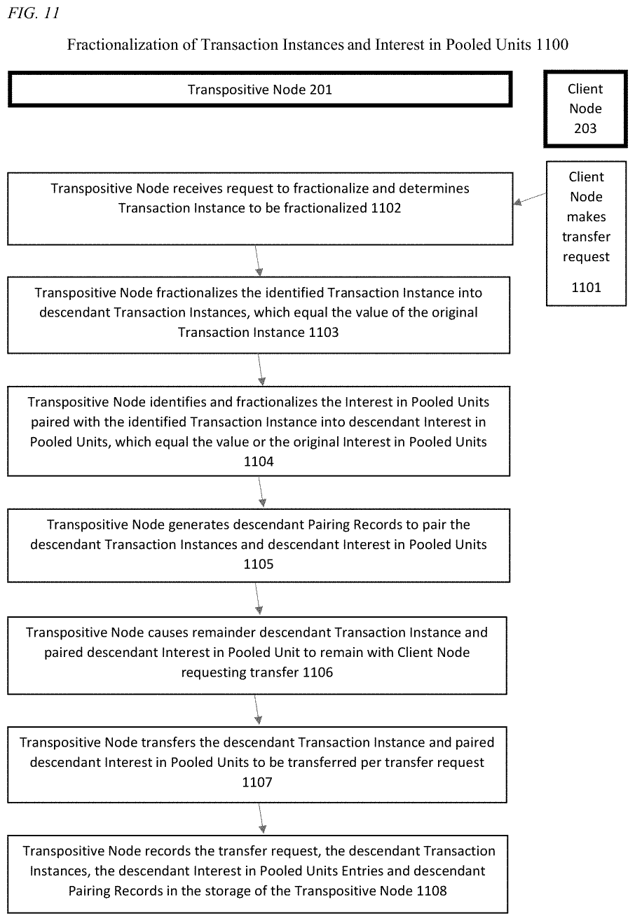

FIG. 11 is a diagram depicting Fractionalization of Transaction Instances and Interest in Pooled Units 1100. A User might desire to use or spend an amount of a

Transaction Instance that is not equal to or perfectly divisible by the value of a particular Transaction Instance. In such cases, fractionalization of such Transaction Instance will be utilized to enable exchange or transactions in the desired fractionalized amount 1100. In some implementations, the example process is performed by the example network 100, 200, 300 shown in FIGS. 1-3.

In some embodiments, a Client Node 203 makes a transfer request 1101, which requires fractionalization. The Transpositive Node 201 receives such request to transfer and fractionalize and determines the Transaction Instance to be fractionalized and transferred 1102.

The Transpositive Node 201 fractionalizes the identified Transaction Instance into descendant Transaction Instances, which equal the value of the original Transaction Instance 1103.

The Transpositive Node 201 identifies and fractionalizes the Interest in Pooled Units paired with the identified Transaction Instance into descendant Interest in Pooled Units, which equal the value or the original Interest in Pooled Units 1104.

The Transpositive Node 201 generates descendant Pairing Records to pair the descendant Transaction Instances and descendant Interest in Pooled Units 1105.

The Transpositive Node 201 causes the remainder descendant Transaction Instance and paired descendant Interest in Pooled Unit to remain with Client Node requesting transfer 1106.

The Transpositive Node 201 transfers the descendant Transaction Instance and paired descendant Interest in Pooled Units to be transferred per transfer request 1107.

The Transpositive Node 201 records the transfer request, the descendant Transaction Instances, the descendant Interest in Pooled Units Entries and descendant Pairing Records in the storage of the Transpositive Node 1108.

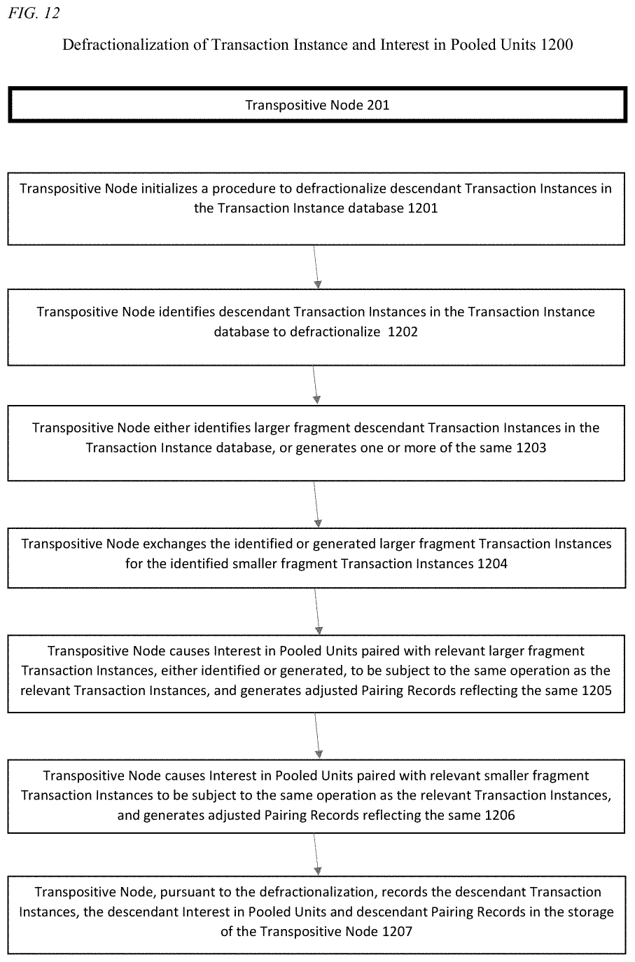

FIG. 12 is a diagram depicting Defractionalization of Transaction Instance and Interest in Pooled Units 1200. Due to the burden on the Network of fractionalization, particularly as it successively breaks Transaction Instances down into smaller and smaller fragments over successive transfers, conservation of use of Network resources benefits from a program of defractionalization 1200. In some implementations, the example process is performed by the example network 100, 200, 300 shown in FIGS. 1-3.

In such embodiments, the Transpositive Node 201 initializes a procedure to defractionalize descendant Transaction Instances in the Transaction Instance database 1201. The Transpositive Node 201 identifies descendant Transaction Instances in the Transaction Instance database to defractionalize 1202.

The Transpositive Node 201 either identifies larger fragment descendant Transaction Instances in the Transaction Instance database, or generates one or more of the same 1203.

The Transpositive Node 201 exchanges the identified or generated larger fragment Transaction Instances for the identified smaller fragment Transaction Instances 1204.

The Transpositive Node 201 causes Interest in Pooled Units paired with relevant larger fragment Transaction Instances, either identified or generated, to be subject to the same operation as the relevant Transaction Instances, and generates adjusted Pairing Records reflecting the same 1205.

The Transpositive Node 201 causes Interest in Pooled Units paired with relevant smaller fragment Transaction Instances to be subject to the same operation as the relevant Transaction Instances, and generates adjusted Pairing Records reflecting the same 1206.

The Transpositive Node 201, pursuant to the defractionalization, records the descendant Transaction Instances, the descendant Interest in Pooled Units and descendant Pairing Records in the storage of the Transpositive Node 1207.

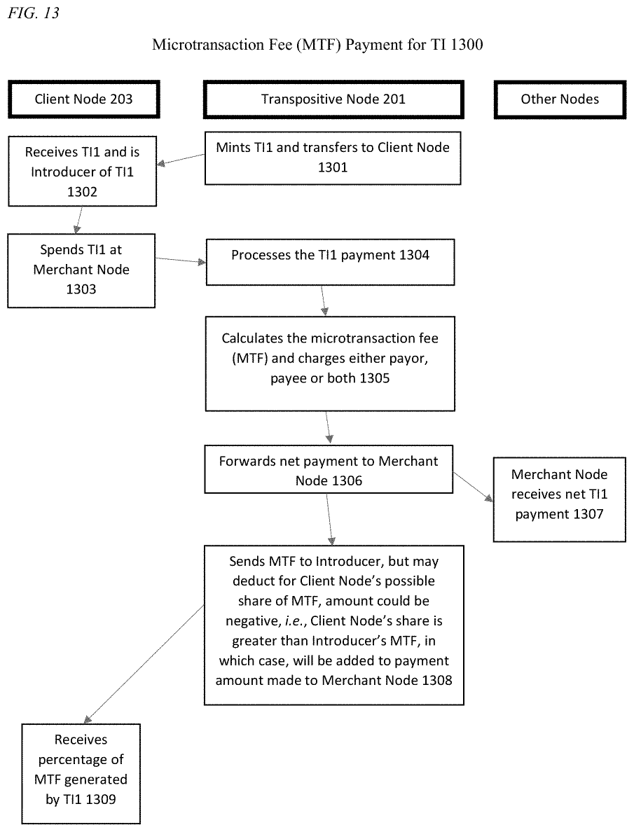

FIG. 13 is a diagram depicting Microtransaction Fee (MTF) payment for TI 1300. In various embodiments, a Transpositive Node Network 200 may be enabled to track TI from introduction until retirement, maintaining certain data in the Transaction Instance database related to such TI that was originally introduced. Such original introduction data may be maintained as part of the Transaction Instance despite multiple generations of transactions and fractionalizations. Based on such records, an Introducer of TI might receive MTF for downstream use of such TI introduced by the Introducer 1300. Such MTF might be participation in actual transaction fees generated by use of such TI. In some implementations, the example process is performed by the example network 100, 200, 300 shown in FIGS. 1-3.

100961 As illustration only, a Transpositive Node 201 mints TI1 and transfers it to a Node, a Client Node 203, for example 1301. Such Client Node receives such TI1 and is deemed the Introducer thereof 1302. Such Client Node 203 spends the TI1 at Merchant Node 1303.

The Transpositive Node 201 processes the TI1 payment 1304 and calculates the MTF and charges either payor, payee or both 1305, and forwards net payment to Merchant Node 1306. The Merchant Node receives net TI1 payment 1307.

The Transpositive Node 201 transmits MTF to Introducer, but may deduct for the Client Node's 203 possible share of MTF, and the amount could be negative, i.e., Client Node's share is greater than Introducer's MTF, in which case, will be added to payment amount made to Merchant Node 1308. The Client Node 203 receives percentage of MTF generated by TI1 1309.

The Transpositive Node Network 200 would also compensate for the possibility that Users would intentionally retire TI with the goal of reintroducing it to receive credit as a TI Introducer. The Transpositive Node Network 200 could do this by models predicting unfair behavior based on churn, time between transactions, patterns of retiring and introducing TI and other factors. In addition, various penalties could be imposed for retiring TI, particularly when the same or related User repurchases TI as an Introducer.

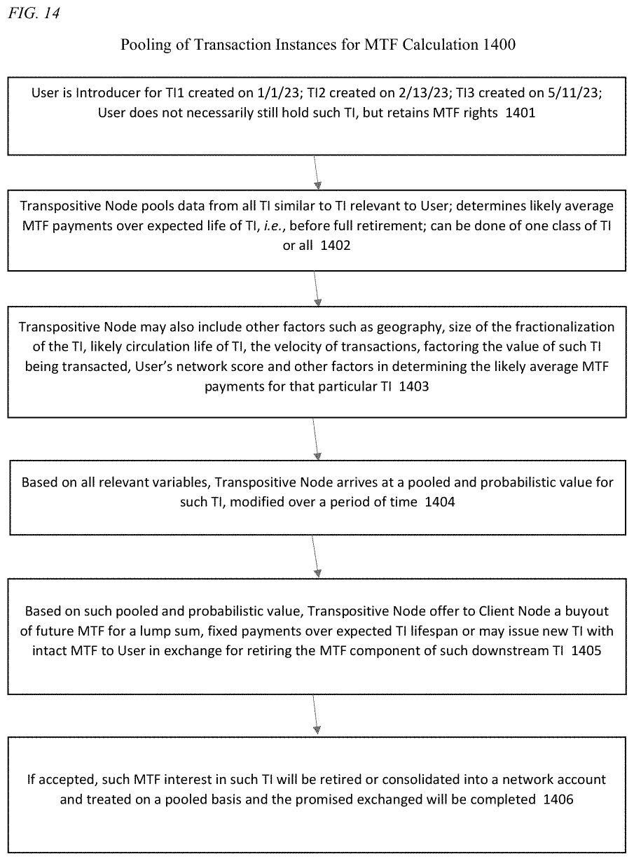

FIG. 14 is a diagram depicting Pooling of Transaction Instances for MTF calculation 1400. In some embodiments, metadata, pooling and probabilistic calculation may be utilized to assign certain TI or classes of TI held by a User with a metavalue to simplify calculations of MTF payments for Introducers or other Users 1400. In some implementations, the example process is performed by the example network 100, 200, 300 shown in FIGS. 1-3.

As illustration only, a Node, for example, a Client Node 203, might have been the Introducer for TI1 created on 1/1/23; TI2 created on 2/13/23; and EC3 created on 5/11/23. Such User does not necessarily still hold such TI, but might retain MTF rights

Such TI has been providing a certain stream of revenue to the Client Node 203, but according to network calculations, that amount decreases over time. Also, on the Transpositive Node Network 200 side, as time passes from the creation of TI, the amount and complexity of calculation of MTF payments becomes more resource-consuming, for smaller amounts of money, thus it is in the Transpositive Node's 201 interest to modify the basis for the MTF payment calculation.

One possibility is for the Transpositive Node 201 to collect metadata from similar TI, pool such data and make a probabilistic determination of the likely average MTF payments for such TI 1402. The Transpositive Node may also include other factors such as geography, size of the fractionalization of the TI, likely circulation life of TI, the velocity of transactions, factoring the value of such TI being transacted, User's network score and other factors in determining the likely average MTF payments for that particular TI 1403.

Based on all relevant variables, the Transpositive Node 201 arrives at a pooled and probabilistic MTF value for such TI, modified over a period of time 1404. Based on such pooled and probabilistic value, the Transpositive Node 201 may present an offer to the User for a buyout of future MTF for a lump sum, fixed payments over expected TI lifespan or may issue new TI with intact MTF to User in exchange for retiring the MTF component of such downstream TI 1405.

If accepted by the Client Node 203, such MTF interest in such TI will be retired or consolidated into a network account and treated on a pooled basis and the promised exchange will be completed 1406.

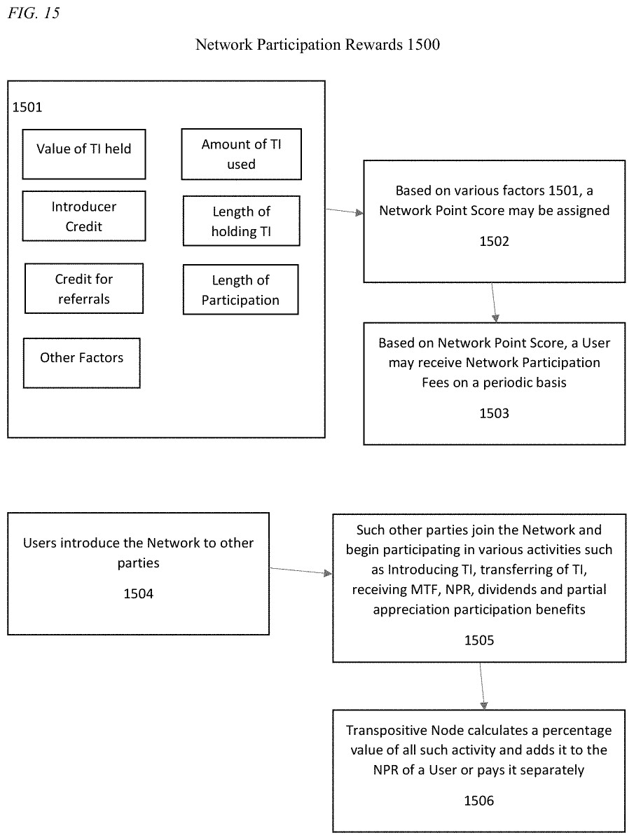

FIG. 15 is a diagram depicting Network Participation Rewards (NPR) 1500. In some embodiments, Users might be accorded a bonus with network participation rewards (“NPR”) 1500. Such NPR could be calculated according to the value of TI held, the amount of TI used, Introducer credit earned, length of time of holding TI and how much, credit for User referrals, length of User participation and other factors 1501. In some implementations, the example process is performed by the example network 100, 200, 300 shown in FIGS. 1-3.

Based on such various factors 1501, an NPR point score 1502 may be assigned to a User. Based on such NPR point score 1502, a User might receive NPR on a periodic basis 1503. In addition, Users might introduce the Network to other parties 1504. Such other parties join the Network and begin participating in various activities such as Introducing TI, transferring of TI, receiving MTF, NPR, dividends and appreciation benefits 1505. The Transpositive Node may calculate a percentage value of all such activity and adds it to the NPR of a User or pays it separately 1506.

NPR may be used to incentivize any actions desired, and may also be used on a cross-platform basis with other networks. NPR may also be earned by participating in educational opportunities regarding Network offerings or other goods and services.

In some embodiments, Users might be accorded rankings or points for other activities or characteristics, such as ratios of buying TI to selling, or average time held of TI, with credit provided to Users who commit to purchasing or holding TI in greater amounts or ratios and for longer periods of time.

Nodes may also offer incentives and rewards to other Users related to such Nodes services, products or relationships. For example, Users paying for goods and services using a Transpositive Node's TI could receive greater discounts and loyalty rewards than if another currency were used.

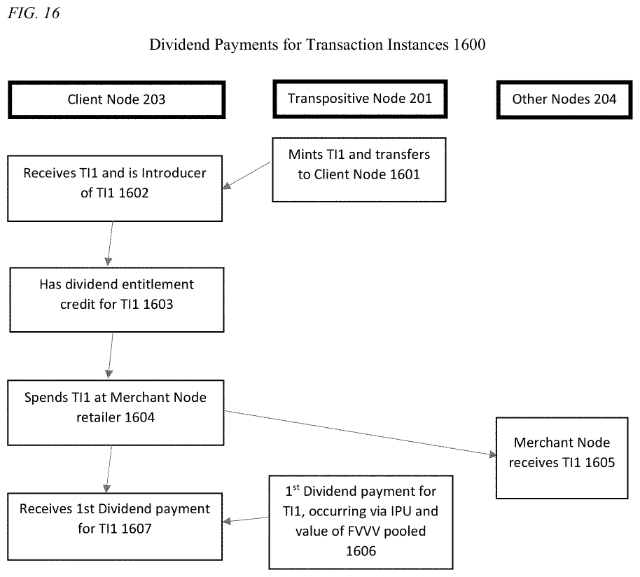

FIG. 16 is a diagram depicting Dividend Payments for Transaction Instances 1600. In some embodiments, the disclosed technology would enable providing participation in dividend payments for IPU to Introducers and possibly subsequent holders. Such dividend payments could be based on the fractionalization, notional pooling, metadata and probabilistic principles applied to FVVV appreciation and other rewards described herein 1600. In some implementations, the example process is performed by the example network 100, 200, 300 shown in FIGS. 1-3.

In some embodiments, a Transpositive Node 201 might mint TI1 and transfer it to a Node, e.g., a Client Node 1601. The Client Node 203 would receive such TI1 and would be deemed the Introducer of such TI1 1602. Such Introducer would receive certain entitlement to dividends related to such TI1, which might continue even after such Introducer has transferred such TI1 1603.

The Client Node 203 might spend such TI1 at a Merchant Node retailer 1604. The Merchant Node retailer would receive such TI1 1605. Even though the Client Node 203 does not possess TI1 any longer, at the time of the first dividend payment for TI1, the dividend payment might be paid to the Client Node as the Introducer of TI1 1606. The Client Node, as Introducer, would receive all or part of such dividend payment for TI1 1607. Note that as TI is retired, such dividend payments would no longer be provided, and such dividend payments might be subject to expiration or pooling.

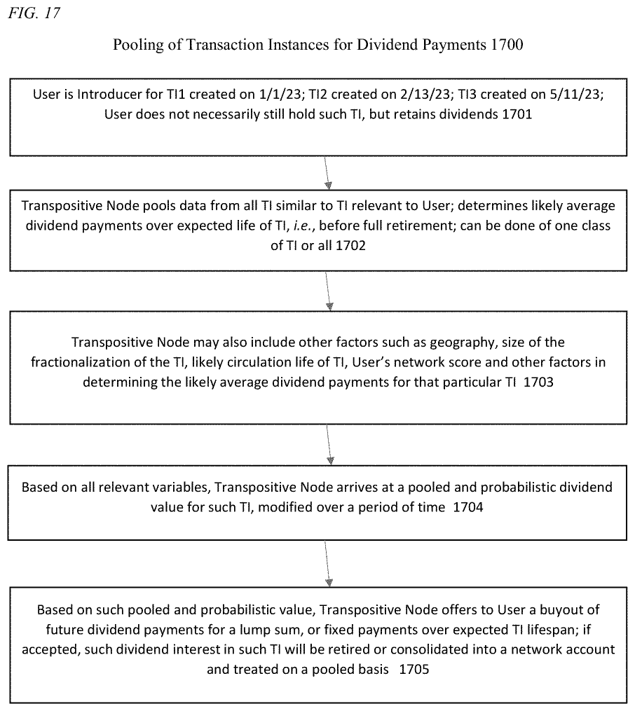

FIG. 17 is a diagram depicting Pooling of Transaction Instances for Dividend Payments 1700. In some embodiments, metadata, pooling and probabilistic calculation may be utilized to assign certain TI or classes of TI held by a User with a metavalue, to simplify calculations of dividend payments for Introducers or other Users 1700. In some implementations, the example process is performed by the example network 100, 200, 300 shown in FIGS. 1-3.

As illustration only, a Node, for example, a Client Node 203, might have been the Introducer for TI1 created on 1/1/23; TI2 created on 2/13/23; and EC3 created on 5/11/23. Such User does not necessarily still hold such TI, but might retain dividend rights 1701.

Such TI has been providing a certain stream of dividend revenue to the Client Node 203, but according to network calculations, that amount decreases over time. Also, on the Transpositive Node Network 200 side, as time passes from the creation of TI, the amount and complexity of calculation of dividend payment becomes more resource-consuming, for smaller amounts of money, thus it is in the Transpositive Node Network's 200 interest to modify the basis for dividend payment calculation.

One possibility is for the Transpositive Node 201 to collect metadata from similar TI, pool such data and make a probabilistic determination of the likely average dividend payments for such TI 1702. The Transpositive Node 201 may also include other factors such as geography, size of the fractionalization of the TI, likely circulation life of TI, the velocity of transactions, factoring the value of such TI being transacted, User's network score and other factors in determining the likely average dividend payments for that particular TI 1703.

Based on all relevant variables, the Transpositive Node 201 arrives at a pooled and probabilistic dividend value for such TI, modified over a period of time 1704. The Transpositive Node 201 may present an offer to Client Node 203 to buy out all future dividend payments for a lump sum, or provide fixed payments over the expected lifespan of such TI based on such probabilistic network value and not actual dividend entitlement, if accepted, such dividend interest in such TI will be retired or consolidated into a network account and treated on a pooled basis 1705.

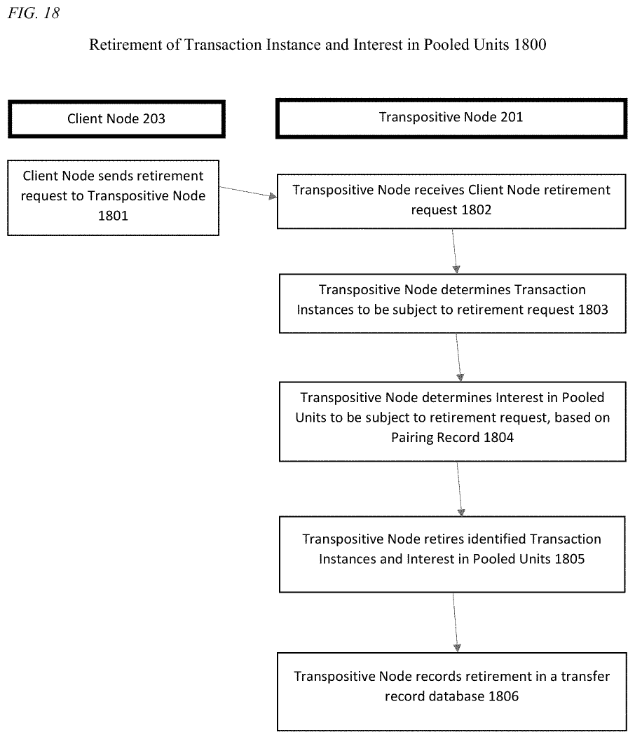

FIG. 18 is a diagram depicting Retirement of Transaction Instance and Interest in Pooled Units 1800. In some embodiments, a Transaction Instance will be retired 1800. A Node, e.g., a Client Node 203, might desire to spend or use a Transaction Instance with a Third-Party Node 204, i.e., a completely out-of-network party. In such cases, the Client Node 203 sends to the Transpositive Node 201 a retirement request 1801. In some implementations, the example process is performed by the example network 100, 200, 300 shown in FIGS. 1-3.

The Transpositive Node 201 receives the Client Node 203 retirement request 1802.

The Transpositive Node 201 determines Transaction Instances to be subject to retirement request 1803.

The Transpositive Node 201 determines Interest in Pooled Units to be subject to retirement request, based on the Pairing Record 1804.

The Transpositive Node 201 retires the identified Transaction Instances and Interest in Pooled Units 1805.

The Transpositive Node 201 records the retirement in a transfer record database 1806.

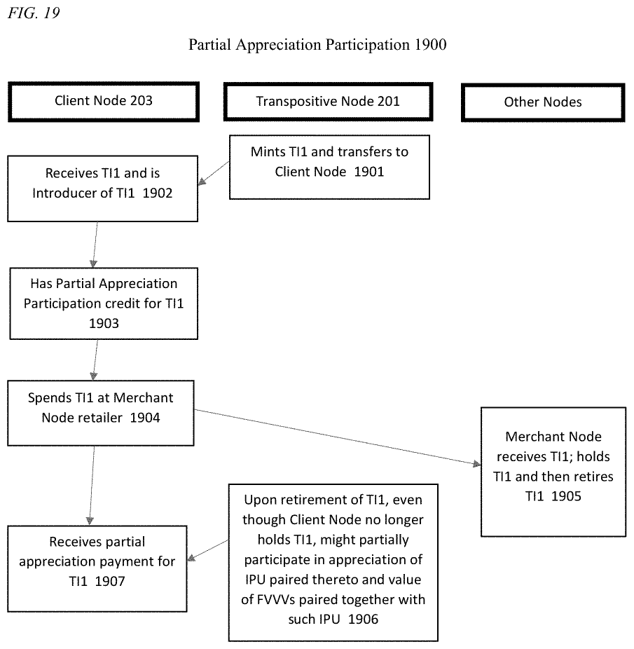

FIG. 19 is a diagram depicting Partial Appreciation Participation 1900. In some embodiments, as enabled by Network tracking of TI ownership and use, an Introducer might be accorded partial appreciation participation in the possible increase of value of an FVVV that is in a pool paired to IPU, which is paired to TI, even though such Introducer no longer holds such TI. In some implementations, the example process is performed by the example network 100, 200, 300 shown in FIGS. 1-3.

In such embodiments, the Transpositive Node 201 would mint TI1 and transfer to a Client Node 203 such TI1 1901. The Client Node 203 receives such TI1 and is Introducer of TI1 1902. Upon such receipt, the Client Node 203 possesses partial appreciation participation credit for such TI1 1903. The Client Node 203 then might spend TI1 at a Merchant Node 205 retailer 1904. The Merchant Node 205 receives such TI1, holds such TI1 and then retires such TI1 1905.

Upon such retirement of TI1, even though the Client Node 203 no longer holds TI1, it might partially participate in appreciation of IPU paired thereto and the value of FVVVs paired together with such IPU 1906.

Upon such retirement, the Introducer might receive a partial appreciation participation payment for such TI1 1907.

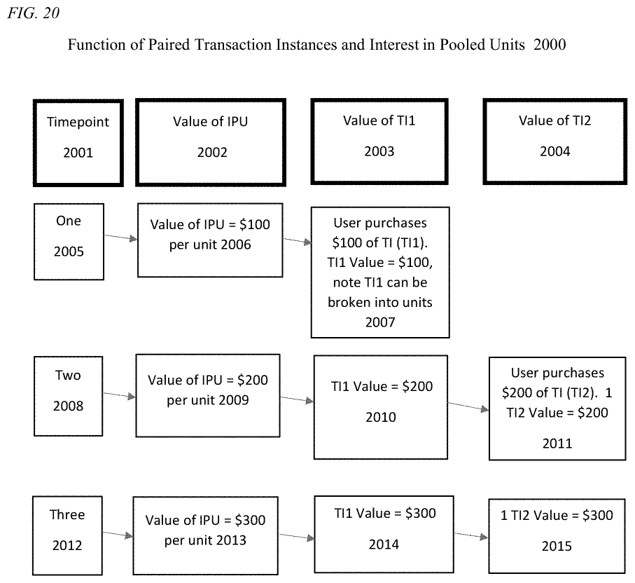

FIG. 20 is a diagram depicting the Function of Paired Transaction Instances and Interest in Pooled Units 2000. Based on FVVV price data, the Transpositive Node 201 would update value of TI paired to IPU 2000. In some implementations, the example process is performed by the example network 100, 200, 300 shown in FIGS. 1-3.

In some implementations, as an illustration only, looking at Timepoints 2001, Value of IPU 2002, Value of TI1 2003 and Value of TI2 2004, it might be possible to see the function of such pairing 2000.

In Timepoint One 2005, the value of a IPU is $100 per unit 2006. At Timepoint One 2005, TI1 is created and paired with a IPU, so that at Timepoint One, the paired IPU and such TI1 have an equivalent value of $100 because of such pairing 2007.

In Timepoint Two 2008, the value of a IPU has increased by $100 and is now $200 per IPU 2009. At Timepoint Two 2008, one IPU and such TI1 still have an equivalent value, and because the IPU is now worth $200, such TI1 is also worth $200 because of such pairing 2010.

At Timepoint Two 2008, where the value of a IPU is $200 per unit 2009, if a User were to purchase new TI, i.e., TI2, the value of such TI2 would be $200, if the equivalent of one IPU were purchased 2011.

In Timepoint Three 2012, the value of the same IPU has increased by a cumulative $200 and is now $300 per unit 2013. At Timepoint Three 2012, one IPU and such TI1 still have an equivalent value, and because the IPU is now worth $300, such TI1 is also worth $300 because of such pairing, if the equivalent of one IPU were purchased

At Timepoint Three 2012, one IPU and such TI2 still have an equivalent value, and because one IPU is now worth $300, such TI2 is also worth $300 because of such pairing, if the equivalent of one IPU were purchased 2015.

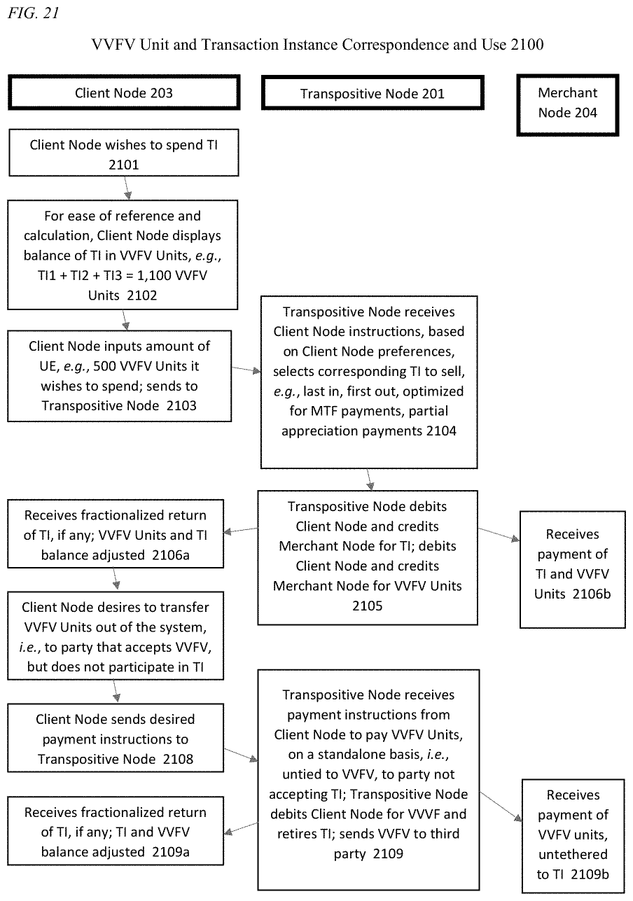

FIG. 21 is a diagram depicting VVFV Unit and Transaction Instance Correspondence and Use 2100. In some embodiments, a dual system of VVFV and TI might be utilized to achieve certain goals 2100, where VVFV is a parallel currency to TI in the Network. While TI is paired with IPU, VVFV may be introduced into such pairing to express the value of TI and IPU in a unit of value that is pegged to an external currency, e.g., USD. VVFV can exist as actual units in an account in the Network or as a conversion reference for Users to more easily understand the value of their holdings. VVFV may also exist only within a Network, or may be traded more broadly without a TI or IPU component, functioning more like a static stablecoin without the downstream or metadata aspects of TI. In some implementations, the example process is performed by the example network 100, 200, 300 shown in FIGS. 1-3.

A Node, e.g., a Client Node 203, wishes to spend TI 2101. For ease of reference and calculation, such Client Node 203 displays the various balances of TI, but also displays the equivalent balances of such TI in VVFV 2102.

The Client Node 203, instead of choosing which TI to spend, instead inputs an amount of VVFV it would like to spend and sends this amount of VVFV to the Transpositive Node 2103. The Transpositive Node 201 receives such instructions, and based on Client Node 203 preferences, the Transpositive Node 201 selects the corresponding TI to sell, pursuant to various selected principles, such as linked to a specific company, last in, first out, optimize selection of TI to spend based on what maximizes MTF payments, dividend payments, partial appreciation participation or network participation rewards 2104. The Transpositive Node 201 then debits the Client Node 203 and credits the Merchant Node 205 for such TI, and debits the Client Node 203 and credits the Merchant Node 205 for such VVFV 2105.

The Client Node 203 receives fractionalized return of TI, if any. The VVFV and TI balance are adjusted 2106a. The Merchant Node receives payment of TI and VVFV 2106b.

In other situations, the Client Node 203 might desire to transfer VVFV out of the TI system, i.e., to another party that accepts VVFV, but does not participate in the TI system 2107. In such case, the Client Node 203, might send to the Transpositive Node 201 the desired payment instructions 2108.

The Transpositive Node 201 would receive the payment instructions from the Client Node 203 to pay VVFV, on a standalone basis, i.e., untied to TI, to a party not accepting TI. The Transpositive Node 201 debits the Client Node 203 for VVFV and retires TI, and sends VVFV to the third-party node 2109. The Client Node 203 receives fractionalized return of TI, if any, TI and VVFV balances are adjusted 2109a. The Merchant Node receives payment of VVFV, untethered to TI 2109b.

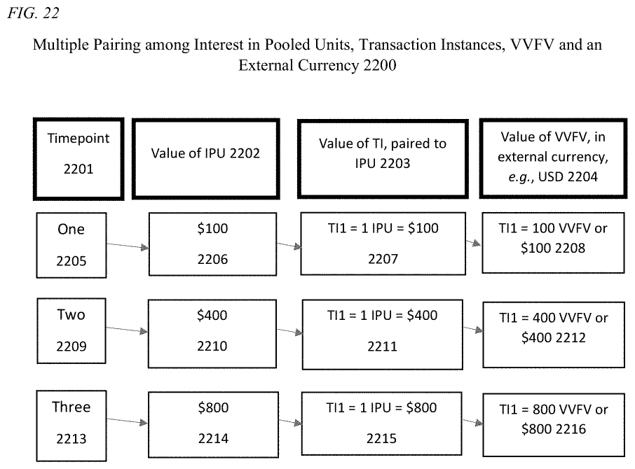

FIG. 22 is a diagram depicting Multiple Pairing among Interest in Pooled Units, Transaction Instances, VVFV and an External Currency 2200. Based on price data for IPU, the Transpositive Node 201 would update the value of TI paired to such IPU. In some embodiments, an additional expression of value, VVFV, that is fixed to an external currency, might be utilized to aid Users in ascertaining the value of their Network holdings more easily, or to facilitate easier exchanges with outside parties. For example, a multiple pairing among IPU, TI, VVFV and an external currency might be utilized in a Network. VVFV might be merely a display value generated by the Transpositive Node 201 for the benefit of easier reference by the Client Node 203 to ascertain the value of the Client Node's 203 account holdings. Alternatively, VVFV may be a digital currency or coin, e.g., a stablecoin issued by the Transpositive Node or another entity, or a digital Dollar, that is added and subtracted continually from the Client Node's 203 account as the value of the holdings in the Client Node's 203 account fluctuates. Further, another alternative is for the Transpositive Node 201 to create on demand, e.g., at the time of transaction, the specific VVFV that will be used in the transaction, according to the value of the transaction and the balance of the value of the holdings in the Client Node's 203 account. In some implementations, the example process is performed by the example network 100, 200, 300 shown in FIGS. 1-3.

In some implementations, as an illustration only, looking at Timepoints 2201, Value of IPU 2202, Value of TI Paired to IPU 2203 and Value of VVFV paired to an external currency 2204, it might be possible to see the function of such multiple pairing

In Timepoint One 2205, the value of a IPU is $100 per unit 2206. At Timepoint One 2205, TI1 is created and paired with one IPU, so that at Timepoint One, the IPU and TI1 have the same value of $100 because of such pairing 2207.

Additionally, in Timepoint One 2205, if 1 VVFV is equal to $1, and such TI1 is worth $100, then such TI1 will be worth 100 VVFV or $100 because of such pairing and equivalence 2208.

In Timepoint Two 2209, the value of the same IPU has increased by $300 and is now $400 per unit 2210. At Timepoint Two 2209, the value of one IPU and such TI1 still have an equivalent value, and because the value of one IPU is now worth $400, such TI1 is also worth $400 because of such pairing 2211. Additionally, in Timepoint Two 2209, if 1 VVFV is equal to $1, and such TI1 is worth $400, then such TI1 will be worth 400 VVFV because of such pairing and equivalence 2212.

In Timepoint Three 2213, the value of a IPU has increased by a cumulative $700 and is now $800 per unit 2214. At Timepoint Three 2213, one IPU and such TI1 still have an equivalent value, and because one IPU is now worth $800, such TI1 is also worth $800 because of such pairing 2215. Additionally, in Timepoint Three 2213, if 1 VVFV is equal to $1, and such TI1 is worth $800, then such TI1 will be worth 800 VVFV because of such pairing and equivalence 2216.

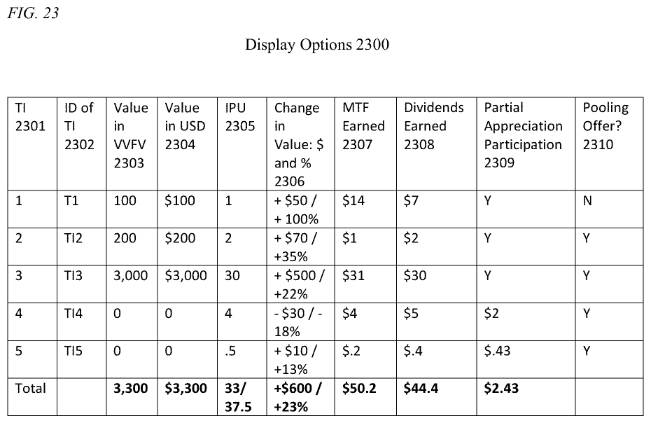

FIG. 23 is a diagram depicting Display Options 2300. In various embodiments, such fractionalization may involve implementation of a complex grid presenting Users with various options for viewing, analyzing and using such Users' TI 2300.

Display options may include a listing of TI 2301, an identification of the TI listed 2302, value of TI in VVFV 2303, value of TI in USD 2304, equivalence of TI in number of IPU 2305, change in value of TI 2306, MTF earned 2307, dividends earned 2308, partial appreciation participation paid 2309 and whether there exists a pooling offer from the Network 2310, and other fields.

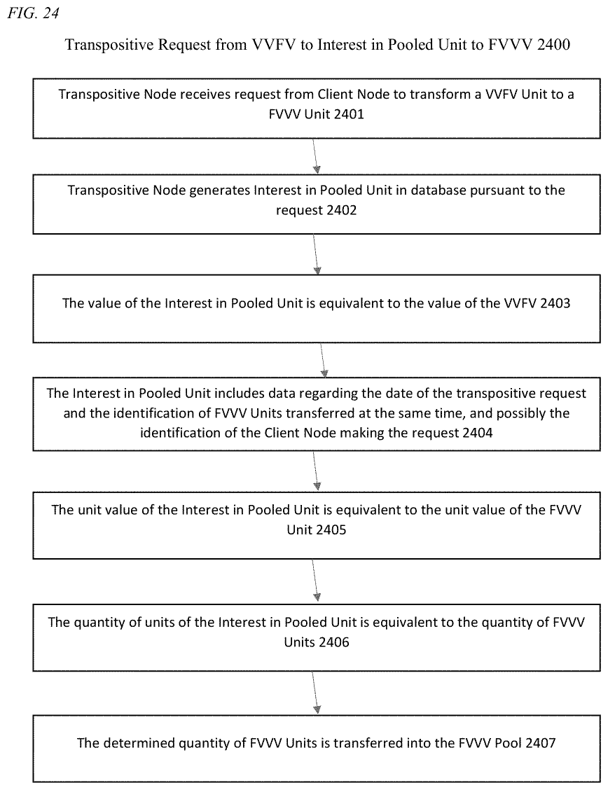

FIG. 24 is a diagram depicting a Transpositive Request from VVFV to Interest in Pooled Unit to FVVV 2400. In various embodiments, a Transpositive Node 201 receives a request from a Client Node 203 to transform a VVFV Unit to a FVVV Unit 2401. In some implementations, the example process is performed by the example network 100, 200, 300 shown in FIGS. 1-3.

The Transpositive Node 201 generates Interest in Pooled Unit in the database pursuant to the request 2402.

The value of the Interest in Pooled Unit is equivalent to the value of the VVFV 2403.

The Interest in Pooled Unit includes data regarding the date of the transpositive request and the identification of FVVV Units transferred at the same time, and possibly the identification of the Client Node 203 making the request 2404.

The unit value of the Interests in Pooled Units is equivalent to the unit value of the FVVV Unit 2405.

The quantity of units of the Interests in Pooled Units is equivalent to the quantity of FVVV Units 2406.

The determined quantity of FVVV Units is transferred into the FVVV Pool 2407.

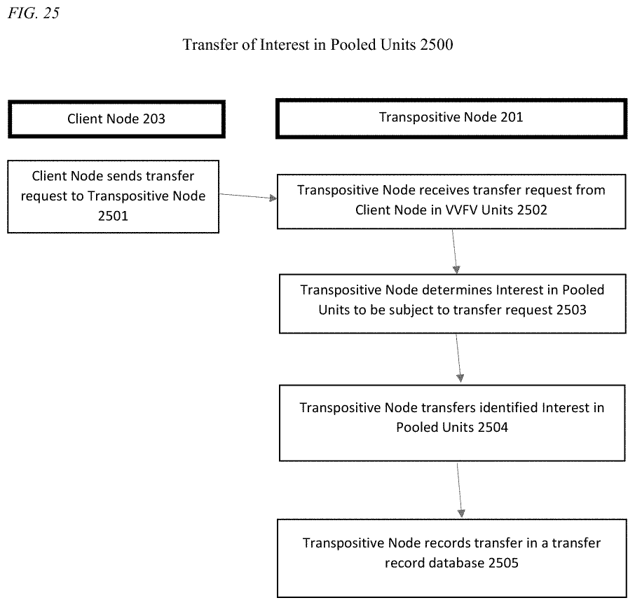

FIG. 25 is a diagram depicting Transfer of Interest in Pooled Units 2500. A Client Node 203 might desire to use or spend an amount of Interests in Pooled Units and such use or spending requires transfer of such Interest in Pooled Units. In some embodiments, a Client Node 203 sends a transfer request to the Transpositive Node 201, which could include data regarding amount and transferee 2501. In such cases, the Transpositive Node 201 receives from the Client Node 203 the transfer request 2502. In some implementations, the example process is performed by the example network 100, 200, 300 shown in FIGS. 1-3.

The Transpositive Node 201 determines the Interest in Pooled Units that will be subject to transfer request 2503.

The Transpositive Node 201 transfers the identified Interest in Pooled Units 2504.

The Transpositive Node 201 records the transfer in a transfer record database 2505.

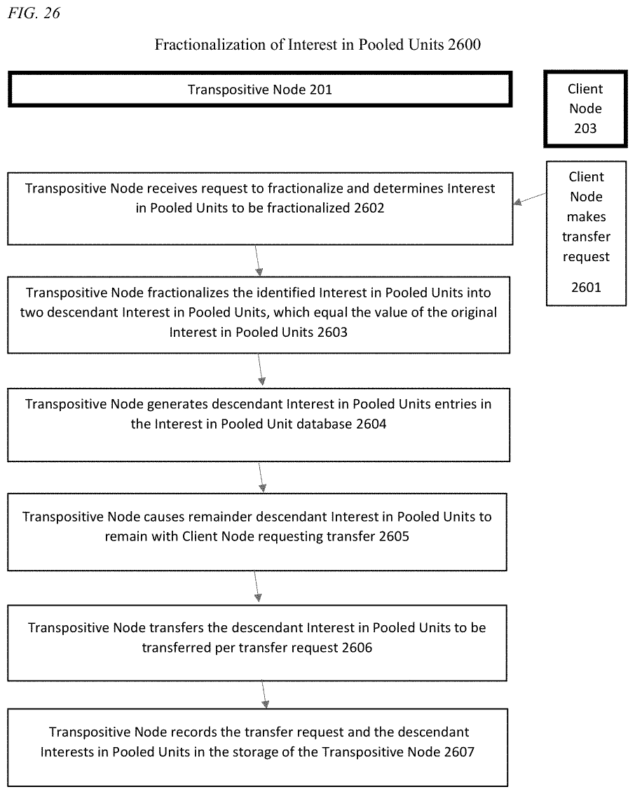

FIG. 26 is a diagram depicting Fractionalization of Interest in Pooled Units 2600. A Client Node might desire to use or spend an amount of an Interest in Pooled Units that is not equal to or perfectly divisible by the value of a particular Interest in Pooled Units. In such cases, fractionalization of such Interest in Pooled Units will be utilized to enable exchange or transactions in the desired fractionalized amount 2600. In some implementations, the example process is performed by the example network 100, 200, 300 shown in FIGS. 1-3.

In some embodiments, a Client Node 203 makes a transfer request 2601, which requires fractionalization. The Transpositive Node 201 receives such request to transfer and fractionalize and determines the Interest in Pooled Units to be fractionalized and transferred 2602.

The Transpositive Node 201 fractionalizes the identified Interest in Pooled Units into two descendant Interests in Pooled Units, which equal the value of the original Interest in Pooled Units 2603.

The Transpositive Node 201 generates descendant Interests in Pooled Units entries in the Interests in Pooled Unit database 2604.

The Transpositive Node 201 causes remainder descendant Interests in Pooled Units to remain with Client Node requesting transfer 2605.

The Transpositive Node 201 transfers the descendant Interest in Pooled Units to be transferred per transfer request 2606.

The Transpositive Node 201 records the transfer request and the descendant Interests in Pooled Units in the storage of the Transpositive Node 2607.

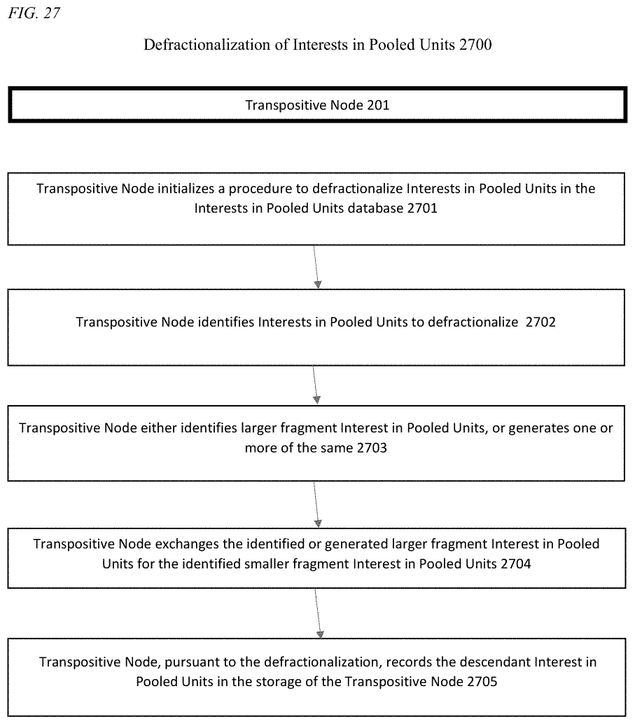

FIG. 27 is a diagram depicting Defractionalization of Interests in Pooled Units 2700. Due to the burden on the Network of fractionalization, particularly as it successively breaks Interests in Pooled Units down into smaller and smaller fragments over successive transfers, conservation of use of Network resources benefits from a program of defractionalization 2700. In some implementations, the example process is performed by the example network 100, 200, 300 shown in FIGS. 1-3.

In such embodiments, the Transpositive Node 201 initializes a procedure to defractionalize Interests in Pooled Units in the Interests in Pooled Units database 2701.

The Transpositive Node 201 identifies Pooled Units in the Interests in the Pooled Units database to defractionalize 2702. Such identification might be based on various characteristics of the Interests in Pooled Units, such as date of creation, location, ease of defractionalization or other factors.

The Transpositive Node 201 either identifies larger fragment Interests in Pooled Units, or generates one or more of the same 2703.

The Transpositive Node 201 exchanges the identified or generated larger fragment Interests in Pooled Units for the identified smaller fragment Interests in Pooled Units 2704.

The Transpositive Node 201, pursuant to the defractionalization, records the descendant Interest in Pooled Units in the storage of the Transpositive Node 2705.

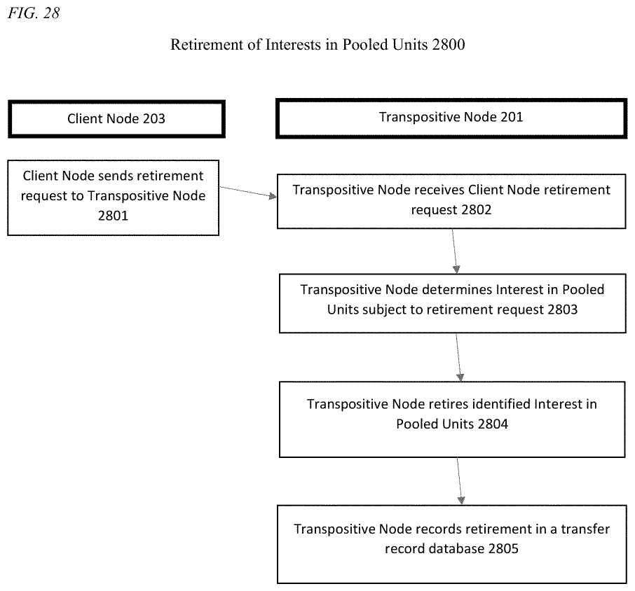

FIG. 28 is a diagram depicting Retirement of Interests in Pooled Units 2800. In some embodiments, an Interest in Pooled Units will be retired 2800. A Node, e.g., a Client Node 203, might desire to spend or use an Interest in Pooled Units with a Third-Party Node 204, i.e., a completely out-of-network party. In such cases, the Client Node 203 sends to the Transpositive Node 201 a retirement request 2801. In some implementations, the example process is performed by the example network 100, 200, 300 shown in FIGS. 1-3.

The Transpositive Node 201 receives the Client Node 203 retirement request 2802.

The Transpositive Node 201 determines Interests in Pooled Units to be subject to retirement request 2803.

The Transpositive Node 201 retires the identified Interests in Pooled Units 2804.

The Transpositive Node 201 records the retirement in a transfer record database 2805.

Loan to a Transpositive Node and Creation of TI based on such Loan. Alternatively, in some embodiments, TI may be created through other methods and steps, such as the Transpositive Node sending an offer to a User to initiate a loan of a certain amount of funds to the Transpositive Node, which would be governed by User loan protocols. Upon viewing such offer to initiate a loan to the Transpositive Node, the User may accept such loan offer by sending a loan acceptance to the Transpositive Node. The Transpositive Node would receive such acceptance of the loan offer.

Based on a loan verification protocol, the Transpositive Node would query the contents of various databases in the Transpositive Node storage or externally, verify the identity of the User, the authenticity of the message containing the acceptance of the loan offer, the account balance in the User account to be debited, and whether the User possess authority or authorization to complete the proposed purchase. If all confirmation values are sufficiently positive, then the Transpositive Node will execute the loan from the User to the Transpositive Node by debiting the User's paying account and crediting the Transpositive Node account receiving such funds. In connection therewith, the Transpositive Node will create a unique identifier and record of such transaction, the loaned funds, the terms thereof, the account and balance, and store such identifiers and records.

In addition, as part of making such loan to the Transpositive Node, the Transpositive Node will create or mint, in a coinbase transaction, unique TI in an amount then equal to the face value of the loan. In some embodiments, such TI may be literally or virtually paired or correlated to FVVVs of the Transpositive Node or to IPU of the Transpositive Node by means of issuing unique identifiers for such pairing or correlation. Such pairing or correlation may be maintained by various fractionalization, pooling or metadata steps, as further described below. Such identifiers and records will be stored by the Transpositive Node and the User initially receiving such TI will be deemed the Introducer of such TI. The Transpositive Node will create a TI account associated with the Introducer, and update the ledger of all TI accounts, and store such records.

The Transpositive Node would then send a TI creation confirmation message to the User and transfer such TI to the User.

In some embodiments, rather than purchase TI, a User can purchase FVVV and commit them to the Network on a custody basis, with predetermined rules and obligations. Based on such FVVV held by the Network in custody, the Network could issue IPU and TI to the User in equivalent amounts, which would be deemed a loan from the Network to the User, secured by the FVVV held in custody by the Network.

In various embodiments, TI may be paired to FVVVs itself and each instantiation of TI, including fractionalizations thereof, would retain pairing with the current, ongoing, present value of such FVVVs. In such embodiments, the value of the specific TI would increase or decrease based on the increase or decrease in value of such FVVVs, and a fixed pairing, which may be whole or partial, between such TI and such FVVVs, would be maintained. Such pairing would require recordkeeping of the value of such FVVVs on the date of TI creation, and updating of the value of such FVVVs on a continuous basis, to determine the value of such TI. Such recordkeeping would be required to be maintained if and when such TI were transferred.

The Transpositive Node may continue to hold such FVVVs for the purposes of maintaining such correlation, or may sell or pledge such FVVVs, and maintain such correlation by use of derivative instruments or contractual obligation, according to the parameters of the relationship set between the Users and the Transpositive Node.

In some embodiments, the Transpositive Node would query an external network or via the same instrumentality, to receive from an external network, price data regarding the relevant FVVVs. Based on such price data, the Transpositive Node update the records of such databases with the most current price information for such FVVVs. Such price information would be stored in one or more databases and be accessible to the Transpositive Node in responding to price inquiries from or to push price data to, other Nodes.

Note that the pairing to either the FVVVs or the external currency may also be adjusted according to a formula, which might include upper and lower bands or limits, and is not necessarily rigid. The paired external currency may be a basket of currencies, and the paired external currency may be changed for another external currency or currencies to offer a different peg for the VVFV.

In some embodiments, in response to ongoing instructions, the Transpositive Node would use such price data to update various User accounts by means of the Transpositive Node calculating the value of VVFV, USD or another store of value available to a User based on the User's holding of TI. Such update would utilize, be based on and update the TI Record. Such calculated value may be sent based on ongoing instructions or a specific request by a Node to the Transpositive Node.

In addition, in all instances in this disclosure, the separate functions of TI and IPU may be combined into a unified currency on the Network. In such case, acquisition of TI would be acquisition of such unified currency, transfer of TI would be transfer of such unified currency, fractionalization and defractionalization of TI would be fractionalization and defractionalization of such unified currency and retirement of TI would be retirement of such unified currency. In such cases, the TI Record and IPU Record would be combined to form a unified currency record, and no Pairing Record would be needed. Such unified currency would function identically as IPU with respect to pairing with the value of the relevant FVVVs, and would function identically as TI with respect to Network transactions and recordkeeping. To the extent desired, such unified currency would enable recordkeeping supporting MTF payments, dividend payments, partial appreciation participation and network participation rewards.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

In a general aspect, a transpositive network is configured for converting variable-volume fixed-value units to fixed-volume variable-value units and vice-versa.

In a first example, a computer system includes means for transposing between a variable-volume fixed-value (VVFV) item comprising VVFV units and a fixed-volume variable-value (FVVV) item comprising FVVV units. The means for transposition implements one or more transpositive network rules.

Implementations of the first example may include one or more of the following features. The transpositive network rules include a rule that specifies:

at inception, the value of the input of VVFV units is equivalent to the value of the output of a created transaction instance.

at inception, the quantity of the input of VVFV units is not required to be equivalent to a quantity of the output of the created transaction instance.

at inception, the VVFV units are not paired by unique identification with the transaction instance, but are paired only in equivalent value.

at inception, the value of the input of the transaction instance is equivalent to the value of the output of the created interests in pooled units.

at inception, the quantity of the input of transaction instance is not required to be equivalent with the quantity of the output of the created interests in pooled units.

at inception, the transaction instance is paired by unique identification with the interests in pooled units.

at inception, the value of the input of the interests in pooled units is equivalent to the value of the output of the identified FVVV units that are transferred into the FVVV unit pool.

at inception, the quantity of the input of the interests in pooled units is equivalent with the quantity of the output of FVVV units.

at inception, the interests in pooled units are not paired by unique identification with the FVVV units, but are paired only in equivalent value.

at inception, the quantity of FVVV units is determined by dividing the unit price of the FVVV units by the value of the transaction instance, which is equivalent with the value of the interests in pooled units.

at inception, the input of the quantity of FVVV units is equivalent to the output of the quantity of interests in pooled units.

at a request of transfer of a transaction instance, the transfer request is expressed in VVFV units.

at a request of transfer, the value of the transfer request expressed in VVFV units is mapped to the value of one or more transaction instances, with such transaction instances being identified to be subject to the transfer.

at a request of transfer, where the value of a transfer request is not equivalent to the value of a transaction instance, a transaction instance is fractionalized to be equivalent with the value of the transfer request by creating two descendant transaction instances, one of which is in the desired fractionalization and the other being the remainder.

a request of transfer, the identified transaction instance and the identified fractionalized, descendant transaction instance are transferred.

at a request of transfer, where a transaction instance is transferred, the paired interests in pooled units are correspondingly transferred.

at a request of transfer, when a transaction instance has been fractionalized for transfer, the paired interests in pooled units are correspondingly fractionalized, and the identified descendant fractionalized interests in pooled units are correspondingly transferred.

at a request of transfer, where a transaction instance and interests in pooled units have been fractionalized, the descendant transaction instance and descendant interests in pooled units that have not been transferred remains with the transferor.

at a request of transfer, when the recipient of the transfer is not in the network, the relevant transaction instance and interests in pooled units are deemed retired from the network, and the equivalent value of FVVV units is transferred out of the FVVV unit pool and liquidated to an acceptable medium of exchange to be transferred to the out-of-network recipient.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.
All references herein to:
dividend means any benefit accorded to a holder of an FVVV;
FVVV or store of value means a Fixed-Volume, Variable-Value unit, which might be shares, equity, securities, debt, derivatives, commodities, digital currencies, cryptocurrencies, fiat currencies, tokens, or other stores of value;
Fixed-Volume, Variable-Value Units Pool means the pool into which the Fixed-Volume, Variable-Value Units are transferred when brought into the Network, with such Pool being effected by segregated account or obligation.
Introducer means the User who is the initial introducer of a Transaction Instance;
IPU means an Interest in Pooled Unit;
MTF means Microtransaction Fees;
Network means the Transpositive Network Computing System;
Nodes may sometimes additionally refer to the operator thereof, i.e., a reference to a client node (“Client Node”), merchant node (“Merchant Node”), company node (“Company Node”) or Transpositive node (“Transpositive Node”); in addition, “Nodes” or “Node,” might alternatively refer to the individual or entity operating such Node;
NPR means Network Participation Rewards;
Out-of-Network means outside the Network, an entity that is Out-of-Network would be a Third-Party Node is a node that is not a member of the Network and does not accept Transaction Instances as valid payment. To effect payment from within the Network to a Third-Party Node it is necessary to convert value in the network to a Variable-Volume, Fixed-Value unit of exchange accepted by that Third-Party Node;
TI means Transaction Instance also known as transaction entry or transaction instance entry interchangeably as described in this disclosure;
TI, VVFV, IPU and FVVV also means references to fractions thereof;
unified currency means a single currency of TI and IPU combined to exist as one unitary denomination including the functionalities of both TI and IPU; and,
User means a user of the Network
VVFV or unit of exchange means a Variable-Volume, Fixed-Value unit, which might be a fiat currency, stablecoin, cryptocurrency or other unit of exchange.

1. A computer system, comprising:
means for transposing between a variable-volume fixed-value (VVFV) item comprising VVFV units and a fixed-volume variable-value (FVVV) item comprising FVVV units, wherein the means for transposition implements one or more transpositive network rules.

2-20. (canceled)

21. The computer system of claim 1, wherein the transpositive network rules comprise one or more rules that specify:
a value of an input of the VVFV units is equivalent to a value of an output of a transaction instance;
a quantity of the input of the VVFV units is not required to be equivalent to a quantity of the output of the transaction instance; and
the VVFV units are not paired by unique identification with the transaction instance, and are paired only in equivalent value.

22. The computer system of claim 21, wherein the transpositive network rules comprise one or more rules that specify:
a value of an input of the transaction instance is equivalent to a value of an output of interests in pooled units;
a quantity of the input of the transaction instance is not required to be equivalent with a quantity of the output of the interests in pooled units; and
the transaction instance is paired by unique identification with the interests in pooled units.

23. The computer system of claim 22, wherein the transpositive network rules comprise one or more rules that specify:
a value of an input of the interests in pooled units is equivalent to a value of an output of identified FVVV units that are to be transferred into an FVVV unit pool;
a quantity of the input of the interests in pooled units is equivalent with a quantity of the output of the identified FVVV units that are to be transferred into the FVVV unit pool;
the interests in pooled units are not paired by unique identification with the identified FVVV units that are to be transferred into the FVVV unit pool, and are paired only in equivalent quantity and value;
a quantity of the identified FVVV units that are to be transferred into the FVVV unit pool is determined by dividing the value of the input of the transaction instance by a unit price of the identified FVVV units that are to be transferred into the FVVV unit pool, which value of the transaction instance is equivalent with the value of the input of the interests in pooled units; and
a quantity of an input of the identified FVVV units that are to be transferred into the FVVV unit pool is equivalent to the quantity of the output of the interests in pooled units.

24. The computer system of claim 23, wherein the transpositive network rules comprise one or more rules that specify:
at a request of transfer of one or more transaction instances in whole or in part, the request of transfer is expressed in the VVFV units;
a value of the request of transfer is mapped to a value of the one or more transaction instances, with the one or more transaction instances being identified to be subject to the request of transfer;
in response to the value of the request of transfer being not equivalent to the value of the one or more transaction instances, one of the one or more transaction instances is fractionalized to create equivalence with the value of the request of transfer by creating two descendant transaction instances, comprising a first descendant transaction instance being in a desired fractionalization and a second descendant transaction instance being the remainder, and the first descendant transaction instance is transferred from a transferor to a recipient;
the paired interest in pooled units corresponding to the fractionalized transaction instance is correspondingly fractionalized by creating two descendant fractionalized interests in pooled units, wherein a first descendant fractionalized interest in pooled units is a desired fractionalization and a second descendant fractionalized interest in pooled units is the remainder, and the first descendant fractionalized interest in pooled units is correspondingly transferred from the transferor to the recipient;
the second descendant transaction instance and the second descendant fractionalized interest in pooled units that have not been transferred to the recipient remain with the transferor; and
when the transaction instance is transferred, the paired interests in pooled units are correspondingly transferred from the transferor to the recipient; and in response to the recipient being out of the transpositive network, the transaction instance and the paired interests in pooled units to be transferred are deemed retired from the transpositive network, and an equivalent value of identified FVVV units is transferred out of the FVVV unit pool and liquidated to an acceptable medium of exchange to be transferred to the recipient.
